(19) United States
(12) Patent Application Publication
(10) Pub. No.: US 2021/0039669 A1
(43) Pub. Date: Feb. 11, 2021

(54) VALIDATING VEHICLE OPERATION USING PATHWAY ARTICLES

(71) Applicant: 3M INNOVATIVE PROPERTIES COMPANY, St. Paul, MN (US)

(72) Inventors: Benjamin W. Watson, Hampshire (GB); John A. Wheatley, Stillwater, MN (US); James B. Snyder, Minneapolis, MN (US); Kenneth L. Smith, White Bear Lake, MN (US)

(21) Appl. No.: 16/965,701

(22) PCT Filed: Feb. 4, 2019
(86) PCT No.: PCT/US2019/016447

§ 371 Date: Jul. 29, 2020

Related U.S. Application Data
(60) Provisional application No. 62/627,693, filed on Feb. 7, 2018.

(51) Int. Cl. B60W 50/14; G06K 9/00

(52) U.S. Cl. CPC B60W 50/14; G06K 9/00798; B60W 2420/42; B60W 2420/52; B60W 2552/53

(57) ABSTRACT

In some examples, a method of validating operation of a vehicle, includes determining, by the vehicle, a first version of a vehicle operating parameter via a vehicle instrument employed in a first measurement approach; calculating, by the vehicle, a second version of the vehicle operating parameter based on information indicated by two or more pathway articles associated with a vehicle pathway; determining, by the vehicle, if the first version of the vehicle operating parameter is approximately equal to the second version of the vehicle operating parameter; if the first version of the vehicle operating parameter is approximately equal to the second version of the vehicle operating parameter, validating the first measurement approach; and if the first version of the vehicle operating parameter is not approximately equal to the second version of the vehicle operating parameter, performing, by the vehicle, one or more actions.

### TECHNICAL FIELD

The present application relates generally to driver assistance systems for vehicles and, in particular, to validating the performance of such driver assistance systems.

### BACKGROUND

For the foreseeable future, our roads will host vehicles encompassing a wide range of driver assistance systems. The vehicles may include vehicles with fully automated guidance systems, vehicles with semi-automated guidance systems and vehicles with little or no driver assistance. Automated and semi-automated driver assistance systems may include adaptive features that automate lighting, provide adaptive cruise control, automate braking, incorporate GPS/traffic warnings, connect to smartphones, alert driver to other cars or dangers, keep the driver in the correct lane, show what is in blind spots and other such features. Infrastructure may increasingly become more intelligent by including systems to help vehicles move more safely and efficiently via sensors, communication devices and other systems installed as part of the infrastructure. Over the next several decades, vehicles of all types, manual, semi-automated and automated, may operate on the same roads and may need to operate cooperatively and synchronously for safety and efficiency.

### SUMMARY

In some examples, a method of validating operation of a vehicle, includes: determining, by the vehicle, a first version of a vehicle operating parameter via a vehicle instrument employed in a first measurement approach; calculating, by the vehicle, a second version of the vehicle operating parameter based on information indicated by two or more pathway articles associated with a vehicle pathway; determining, by the vehicle, if the first version of the vehicle operating parameter is approximately equal to the second version of the vehicle operating parameter; if the first version of the vehicle operating parameter is approximately equal to the second version of the vehicle operating parameter, validating the first measurement approach; and if the first version of the vehicle operating parameter is not approximately equal to the second version of the vehicle operating parameter, performing, by the vehicle, one or more actions.

In some examples, a system includes: a set of vehicles, each respective vehicle in the set of vehicles comprising: at least one infrastructure sensor that generates infrastructure data descriptive of infrastructure articles that are proximate to the respective vehicle; and a first communication device to transmit the infrastructure data; and a computing device comprising one or more computer processors, a second communication device, and a memory comprising instructions that when executed by the one or more computer processors cause the one or more computer processors to: determine a first version of a vehicle operating parameter via a vehicle instrument employed in a first measurement approach; capture information stored in pathway articles deployed along a pathway; calculate a second version of the vehicle operating parameter based on the information captured from the pathway articles; determine if the first version of the vehicle operating parameter is approximately equal to the second version of the vehicle operating parameter; if the first version of the vehicle operating parameter is approximately equal to the second version of the vehicle operating parameter, validate the first measurement approach; and if the first version of the vehicle operating parameter is not approximately equal to the second version of the vehicle operating parameter, generate an exception.

In some examples, a pathway article, includes a pavement marking material; and a pavement marker attached to the pavement marking material, wherein the pavement marker includes information used to validate a measurement approach used by a vehicle to determine a vehicle operating parameter.

In some examples, a method of validating operation of a vehicle, includes: determining, by the vehicle, a first version of a vehicle operating parameter via a vehicle instrument employed in a first measurement approach; determining whether one or more pathway articles deployed along a pathway are trusted pathway articles; if one or more of the pathway articles are trusted pathway articles, calculating one or more second versions of the vehicle operating parameter based on information associated with the one or more trusted pathway articles; comparing the first version of the vehicle operating parameter to the one or more second versions of the vehicle operating parameter; if the first version of the vehicle operating parameter is approximately equal to each of the one or more second versions of the vehicle operating parameter, validating the first measurement approach; and if the first version of the vehicle operating parameter is not approximately equal to each of the one or more second versions of the vehicle operating parameter, performing, by the vehicle, one or more actions.

In some examples, a system includes: a set of vehicles, each respective vehicle in the set of vehicles comprising: at least one infrastructure sensor that generates infrastructure data descriptive of infrastructure articles that are proximate to the respective vehicle; and a first communication device to transmit the infrastructure data; and a computing device comprising one or more computer processors, a second communication device, and a memory comprising instructions that when executed by the one or more computer processors causes the one or more computer processors to: determine a first version of a vehicle operating parameter via a vehicle instrument employed in a first measurement approach; capture information stored in pathway articles deployed along a pathway; determine whether one or more pathway articles deployed along a pathway are trusted pathway articles; if one or more of the pathway articles are trusted pathway articles, calculate one or more second versions of the vehicle operating parameter based on the information captured from the trusted pathway articles; comparing the first version of the vehicle operating parameter to the one or more second versions of the vehicle operating parameter; if the first version of the vehicle operating parameter is approximately equal to each of the one or more second versions of the vehicle operating parameter, validate the first measurement approach; and if the first version of the vehicle operating parameter is not approximately equal to each of the second versions of the vehicle operating parameter, generate an exception.

In some examples, a method of validating operation of a vehicle, includes: deploying two or more pavement markers at known locations on pavement marking material; determining a first version of a vehicle operating parameter via a vehicle instrument employed in a first measurement approach; capturing information encoded in two of the pavement markers; calculating a second version of the vehicle operating parameter based on the information captured from the two pavement markers; and determining if the first version of the vehicle operating parameter is approximately equal to the second version of the vehicle operating parameter.

In some examples, a system includes: a set of vehicles, each respective vehicle in the set of vehicles comprising: at least one infrastructure sensor that generates infrastructure data descriptive of infrastructure articles that are proximate to the respective vehicle; and a first communication device to transmit the infrastructure data; a computing device comprising one or more computer processors, a second communication device, and a memory comprising instructions that when executed by the one or more computer processors cause the one or more computer processors to: determine a first version of a vehicle operating parameter via a vehicle instrument employed in a first measurement approach; capture information encoded in two of pavement markers deployed at known locations on pavement marking material; calculate a second version of the vehicle operating parameter based on the information captured from the two pavement markers; and determine if the first version of the vehicle operating parameter is approximately equal to the second version of the vehicle operating parameter.

In some examples, a method of validating operation of a vehicle, includes: determining a first version of a vehicle operating parameter via a vehicle instrument employed in a first measurement approach; authenticating one or more pathway articles deployed along a pathway; capturing information encoded in the authenticated pathway articles; calculating a second version of the vehicle operating parameter based on the information captured from the authenticated pathway articles; determining if the first version of the vehicle operating parameter is approximately equal to the second version of the vehicle operating parameter; if the first version of the vehicle operating parameter is approximately equal to the second version of the vehicle operating parameter, validating the first measurement approach; and if the first version of the vehicle operating parameter is not approximately equal to the second version of the vehicle operating parameter, generating an exception.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating a traffic management system using a pathway article configured to be interpreted by a pathway-article assisted vehicle (PAAV), in accordance with techniques of this disclosure.

FIGS. 2A and 2B are conceptual diagrams showing top views of a pathway article in which pavement markers are placed or formed at defined intervals in pavement marking material, in accordance with techniques of this disclosure.

FIGS. 3A-3D illustrate representative acoustic signals generated by an example of a pathway article, in accordance with techniques of this disclosure.

FIG. 4 is a conceptual diagram of a cross-sectional view of an example of a pathway article in accordance with techniques of this disclosure.

FIGS. 5A and 5B illustrate cross-sectional views of portions of an article message formed on a retroreflective sheet, in accordance with one or more techniques of this disclosure.

FIG. 6 is a block diagram illustrating another example system with pathway articles configured to be interpreted by driver assistance systems in accordance with techniques of this disclosure.

FIG. 7 is a block diagram illustrating an example computing device, in accordance with one or more aspects of the present disclosure.

FIG. 8 is a block diagram illustrating another example computing device, in accordance with one or more aspects of the present disclosure.

FIG. 9 is a conceptual diagram illustrating via a flowchart an example approach to validating proper operation of a vehicle, in accordance with one or more aspects of the present disclosure.

FIG. 10 is a conceptual diagram illustrating via a flowchart another example approach for verifying proper operation of a vehicle, in accordance with one or more aspects of the present disclosure.

FIG. 11 is a block diagram depicting a system for validating a parameter determined by a vehicle, according to techniques described in this disclosure.

FIG. 12 is a flow diagram illustrating example operations of a computing device configured to validate a parameter determined by a vehicle via information associated with a pathway article, in accordance with one or more techniques of this disclosure.

FIG. 13 is flowchart illustrating an example mode of operation for a consensus network, according to techniques of this disclosure.

FIG. 14 is flowchart illustrating an example mode of operation for a consensus network, according to techniques of this disclosure.

FIG. 15 is flowchart illustrating an example mode of operation for a consensus network, according to techniques of this disclosure.

FIG. 16 is a workflow diagram illustrating the collection and processing of vehicle sensor data, in accordance with one or more aspects of the present disclosure.

FIG. 17 is a conceptual diagram illustrating via a flowchart an example approach to out-of-band vehicle operating parameter validation, in accordance with one or more aspects of the present disclosure.

FIG. 18 is a workflow diagram illustrating the collection and processing of vehicle sensor data used for maintaining pathway articles such as traffic signs, in accordance with one or more aspects of the present disclosure.

### DETAILED DESCRIPTION

Even with advances in autonomous driving technology, infrastructure, including vehicle roadways, may have a long transition period during which vehicles with fully autonomous guidance systems, vehicles with Advanced Driver Assist Systems (ADAS), and traditional fully human operated vehicles share the road. Practical constraints, such as the service life of vehicles currently on the road, the capital invested in current infrastructure and the cost of replacement, and the time to manufacture, distribute, and install fully autonomous vehicles and infrastructure may make this transition period decades long.

Autonomous vehicles and ADAS, which may be referred to as semi-autonomous vehicles, may use various sensors to perceive the environment, infrastructure, and other objects around the vehicle. Examples of sensors (or “infrastructure sensors”) may include but are not limited to one or more of image sensor, LiDAR, acoustic, radar, Global Positioning Satellite (GPS) location of infrastructure article, time sensor for detection time of infrastructure article, weather sensor for weather measurement at the time infrastructure article is detected. These various sensors combined with onboard computer processing may allow the automated system to perceive complex information and respond to it more quickly than a human driver. In this disclosure, a vehicle may include any vehicle with or without sensors, such as a vision system, to interpret a vehicle pathway.

A vehicle with vision systems or other sensors that take cues from the vehicle pathway may be called a pathway-article assisted vehicle (PAAV). Some examples of PAAVs may include the fully autonomous vehicles and ADAS equipped vehicles mentioned above, as well as unmanned aerial vehicles (UAV) (aka drones), human flight transport devices, underground pit mining ore carrying vehicles, forklifts, factory part or tool transport vehicles, ships and other watercraft and similar vehicles. A vehicle pathway may be a road, highway, a warehouse aisle, factory floor or a pathway not connected to the earth's surface. The vehicle pathway may include portions not limited to the pathway itself. In the example of a road, the pathway may include the road shoulder, physical structures near the pathway such as toll booths, railroad crossing equipment, traffic signs, traffic lights, the sides of a mountain, guardrails, and generally encompassing any other properties or characteristics of the pathway or objects/structures in proximity to the pathway. This will be described in more detail below.

A pathway article, such as an enhanced sign or enhanced pavement markings, in accordance with the techniques of this disclosure may include an article message on the physical surface of the pathway article. In this disclosure, an article message may include images, graphics, characters, such as numbers or letters or any combination of characters, symbols or non-characters. An article message may include human-perceptible information and machine-perceptible information. Human-perceptible information may include information that indicates one or more first characteristics of a vehicle pathway primary information, such as information typically intended to be interpreted by human drivers. In other words, the human-perceptible information may provide a human-perceptible representation that is descriptive of at least a portion of the vehicle pathway. As described herein, human-perceptible information may generally refer to information that indicates a general characteristic of a vehicle pathway and that is intended to be interpreted by a human driver. For example, the human-perceptible information may include words (e.g., “dead end” or the like), symbols, graphics (e.g., an arrow indicating the road ahead includes a sharp turn) or shapes (e.g., signs or lane markings). Human-perceptible information may include the color of the article, the article message or other features of the pathway article, such as the border or background color. For example, some background colors may indicate information only, such as “scenic overlook” while other colors may indicate a potential hazard (e.g., the red octagon of a stop sign, or the double yellow line of a no passing zone).

In some instances, the human-perceptible information may correspond to words or graphics included in a specification. For example, in the United States (U.S.), the human-perceptible information may correspond to words or symbols included in the Manual on Uniform Traffic Control Devices (MUTCD), which is published by the U.S. Department of Transportation (DOT) and includes specifications for many conventional signs for roadways. Other countries have similar specifications for traffic control symbols and devices. In some examples, the human-perceptible information may be referred to as primary information.

According to aspects of this disclosure, a pathway article may also include second, additional information that may be interpreted by a PAAV. As described herein, second information or machine-perceptible information may generally refer to additional detailed characteristics of the vehicle pathway. The machine-perceptible information is configured to be interpreted by a PAAV, but in some examples, may be interpreted by a human driver. In other words, machine-perceptible information may include a feature of the graphical symbol that is a computer-interpretable visual property of the graphical symbol. In some examples, the machine-perceptible information may relate to the human-perceptible information, e.g., provide additional context for the human-perceptible information. In an example of an arrow indicating a sharp turn, the human-perceptible information may be a general representation of an arrow, while the machine-perceptible information may provide an indication of the particular shape of the turn including the turn radius, any incline of the roadway, a distance from the sign to the turn, or the like. The additional information may be visible to a human operator; however, the additional information may not be readily interpretable by the human operator, particularly at speed. In other examples, the additional information may not be visible to a human operator, but may still be machine readable and visible to a vision system of a PAAV. In some examples, an enhanced pathway article may be an optically active article in that the pathway article is readily detectible by vision systems, which may include an infrared camera or other camera configured for detecting electromagnetic radiation in one or more bands of the electromagnetic spectrum, which may include the visible band, the infrared band, the ultraviolet band, and so forth. For example, the pathway articles may be reflective, such as retroreflective, within one or more bands of the electromagnetic spectrum that are readily detectible by visions systems of the computing device 116.

A successful implementation of infrastructure and infrastructure support, such as the pathway articles of this disclosure may include redundant sources of information to verify inputs and ensure the vehicles make the appropriate response. The techniques of this disclosure may provide pathway articles with an advantage for intelligent infrastructures, because such articles may provide information that can be interpreted by both machines and humans. This may allow verification that both autonomous systems and human drivers are receiving the same message.

Redundancy and security may be of concern for a partially and fully autonomous vehicle infrastructure. A blank highway approach to an autonomous infrastructure, i.e., one in which there is no signage or markings on the road and all vehicles are controlled by information from the cloud, may be susceptible to hackers, terroristic ill intent, and unintentional human error. For example, GPS signals can be spoofed to interfere with drone and aircraft navigation. There is, therefore, an opportunity for fixed infrastructure to provide a trusted point of reference to validate connected and autonomous vehicle behavior as being appropriate in relation to environmental conditions, driving conditions, and the intentions of the drivers. Furthermore, there is an opportunity to include authentication mechanisms in the pathway articles that can be used to determine if the pathway articles are genuine. In one example approach, a driver assistance system queries pathway articles encountered while traveling along a road, verifies the pathway articles are authentic, and employs information embedded in the pathway articles to validate connected and autonomous vehicle behavior of the driver assistance system as being appropriate in relation to environmental conditions, driving conditions, and the intentions of the drivers. In one example approach, the infrastructure provides pathway articles external to the vehicle that are used to calculate vehicle parameters such as vehicle proximity, orientation, velocity and the relative direction of the roadside materials to the vehicle. In one such example approach, for instance, a driver assistance system compares a velocity determined by the driver assistance system to a velocity determined as a function of the distance between two pavement markers. If the velocities match within an expected margin of error, the velocity function of the driver assistance system is operating as expected. If the velocities do not match within an expected margin of error, the velocity function of the driver assistance system is not operating as expected and should be repaired.

Properly configured pathway articles may be used as trusted points of reference used to validate connected and autonomous vehicle behavior as being appropriate in accordance with the rules of the road and the current situation. In some example approaches, these trusted points of reference may form part of a new blockchain based solution to provide increased depth and breadth of security, through mutually authenticating peers. In one example approach, information from authenticating peers may be compared and combined with each other to validate safety indicators and vehicle behaviors such as vehicle proximity, orientation, velocity and the relative direction of the roadside materials to the vehicle. This shared authentication may then be used to highlight unauthorized transactions or actions/transactions. For example, a lack of mutual authentication may indicate a potential threat to road safety and may result in immediate intervention. In one example approach, the vehicle ledger may be used in post event analysis of the exception or, in the aggregate as an interstate level record of vehicle events and transactions.

The techniques of this disclosure may be used to provide local, onboard, redundant validation of information received from onboard sensors, from GPS and from the cloud. In one example approach, the pathway articles provide a basis to compare and contrast external trusted points of reference with both the actual behavior of the vehicle and the intentions of the driver. This behavior can be further cross referenced against environmental conditions and driving conditions to ensure safety for road users, while reducing traffic accidents and congestion.

The techniques of this disclosure may also be used to provide out-of-band validation of information received or derived from onboard sensors, from GPS and from the cloud. As noted above, cyber security threats are hurting the economy: NHTSA enforcement authority recalled 1.5 million vehicles in July 2015. Corporations will spend close to $102bn on cyber security in 2020 up from $73.7bn in 2016. In one example approach, cyber security threats may be mitigated by providing externally trusted points of reference that are authenticated out-of-band. For instance, pathway articles may include optically active markers integrated into, e.g., road markings. The infrastructure may employ out of band authentication in the form of, e.g., embedded codes, to authenticate the pathway article before the contents of the article are used to validate one or more aspects of the vehicle's performance. The ‘code’ may be a traditional barcode, or it could be, for example, an acoustic signature or a pattern detected by the vehicle at intervals within a single length of pavement marking material.

The pathway articles of this disclosure may provide additional information to autonomous systems in a manner which is at least partially perceptible by human drivers. Moreover, the techniques of this disclosure may provide solutions that may support the long-term transition to a fully autonomous infrastructure because it can be implemented in high impact areas first and expanded to other areas as budgets and technology allow.

Hence, pathway articles of this disclosure, such as enhanced sign or pavement markings, may provide additional information that may be processed by the onboard computing systems of the vehicle, along with information from the other sensors on the vehicle that are interpreting the vehicle pathway. The pathway articles of this disclosure may also have advantages in applications such as for vehicles operating in warehouses, factories, airports, airways, waterways, underground or pit mines and similar locations Enhanced signs include but are not limited to traffic signs, temporary traffic control materials, vests, license plates, conspicuity tapes, registration labels and validation stickers.

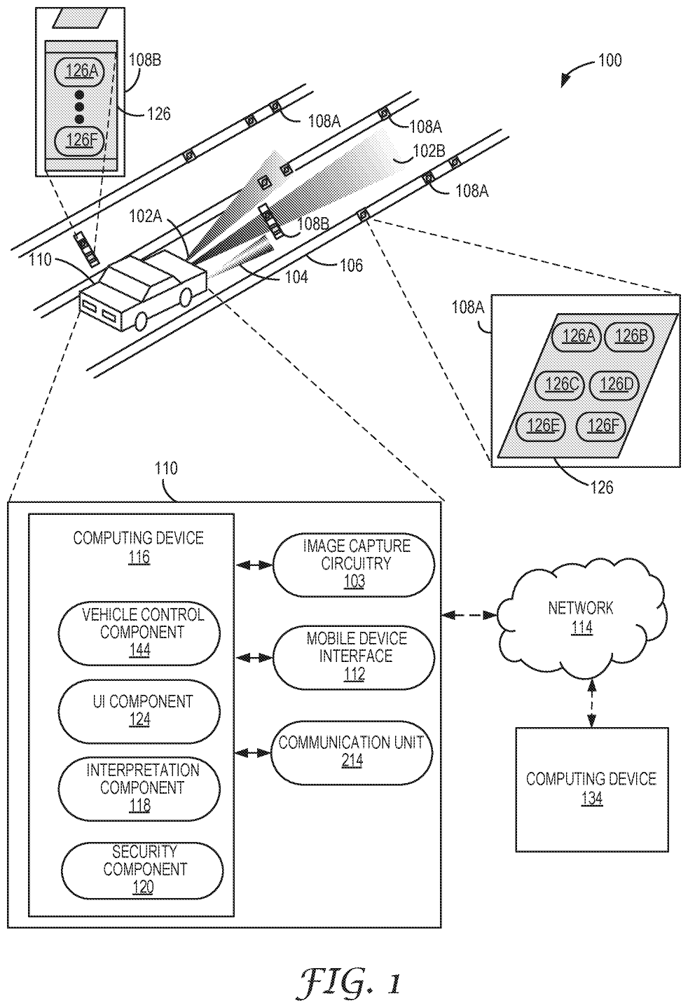

FIG. 1 is a block diagram illustrating a traffic management system using a pathway article configured to be interpreted by a pathway-article assisted vehicle (PAAV), in accordance with techniques of this disclosure. As described herein, PAAV generally refers to a vehicle with a vision system, along with other sensors, that may interpret the vehicle pathway and the vehicle's environment, such as other vehicles or objects. A PAAV may interpret information from the vision system and other sensors, make decisions and take actions to navigate the vehicle pathway.

As shown in FIG. 1, system 100 includes PAAV 110 that may operate on vehicle pathway 106 and that includes image capture devices 102A and 102B and onboard computing device 116. Any number of image capture devices may be possible. The illustrated example of system 100 also includes one or more pathway articles 108 as described in this disclosure, such as pavement markers 108A and 108B. In the example shown in FIG. 1, pavement markers 108A are placed along the direction of traffic flow, while pavement markers 108B are placed in a direction substantially orthogonal to the direction of traffic flow.

Pathway articles 108A, 108B may be deployed in a pre-defined or otherwise known pattern that is detectible by computing device 116. In the example of FIG. 1, three of pathway articles 108A are substantially collinear and separated by distances 109A, 109B that defines a pattern 111 for the three pathway articles 108A. The pattern 111 may identify a location, a vehicle operation context, a pathway characteristic, or other parameter usable for validating the PAAV 110 operation. Instances of such patterns 111 may be defined using any two or more pathway articles 108 arranged in any pattern (not necessarily collinear for instance). The pathway articles 108 used to form pattern 111 may be optically active or acoustic, as described in further detail below.

Interpretation component 118 may obtain, from image capture device(s) 102 via image capture circuitry 103, an image that includes representations of each pathway articles 108 defining pattern 111. Interpretation component 118 may identify the pattern 111 by determining distances 109A, 109B between the pathway articles 108 using one or more image processing algorithms. Interpretation component 118 may map the pattern 111 to validation information in a pattern dictionary that maps patterns to validation information, where the validation information may, e.g., identify a location, a vehicle operation context such as a speed limit for the pattern 111 location, a pathway characteristic, or other parameter usable for validating the PAAV 110 operation.

Interpretation component 118 may additionally, or alternatively, use one or more of distances 109A, 109B between pathway articles 108 to validate the PAAV 110 operation. Any of pathway articles 108 may encode or otherwise by usable for obtaining one or more of distances 109A, 109B to enable PAAV 110 to determine one or more of distances 109A, 109B from the pathway articles 108. For example, a first pathway article 108 may encode or be usable for querying and obtaining a first identifier for itself, a second identifier for a second pathway article 108, and a value for the distance 109A between the first pathway article 108 and the second pathway article 108. Interpretation component 118 may obtain multiple images of pathway articles 108 and interpret changes in the image distance between pathway articles 108 to determine validation information in the form of a speed of PAAV 108 based on the actual distance 109A between the pathway articles 108, for instance. Such determinations of validation information by interpretation component 118 may be used by security component 120 to externally validate the PAAV 110 operation.

As another example, pathway articles 108 may generate an acoustic signature, as described in further detail below. Interpretation component 108 may receive and determine a time between receiving acoustic signatures generated by pathway articles 108 separated by distance 109A. Interpretation component 108 may determine distance 109A using techniques described above, using the pathway articles 108 that generate the acoustic signature, or other pathway articles 108 in the vicinity for instance. Based on the determined time and distance, interpretation component 118 may output a vehicle speed that may be used by security component 120 to externally validate the PAAV 110 operation. Similarly, multiple pathway articles 108 may be separated at a common distance 109A along the pathway 106. Interpretation component 108 may detect pathway articles 108 at a frequency of a number of pathway articles 108 over time, which interpretation component 108 may use to compute the speed of PAAV 110.

As noted above, PAAV 110 of system 100 may be an autonomous or semi-autonomous vehicle, such as an ADAS. In some examples PAAV 110 may include occupants that may take full or partial control of PAAV 110. PAAV 110 may be any type of vehicle designed to carry passengers or freight including small electric powered vehicles, large trucks or lorries with trailers, vehicles designed to carry crushed ore within an underground mine, or similar types of vehicles. PAAV 110 may include lighting, such as headlights in the visible light spectrum as well as light sources in other spectrums, such as infrared. PAAV 110 may include other sensors used to determine the vehicle pathway, the status of the vehicle and of other vehicles in the vicinity, and the environmental conditions around the vehicle. The sensors may include radar, sonar, lidar, environmental and GPS sensors connected to computing device 116. A rain sensor, for example, may operate the vehicle's windshield wipers automatically in response to the amount of precipitation, and may also provide inputs to the onboard computing device 116. Furthermore, PAAV 110 may include communication links connected to computing device 116 that are used to communicate with traffic control infrastructure.

As shown in FIG. 1, PAAV 110 may include image capture devices 102A and 102B, collectively referred to as image capture devices 102. Image capture devices 102 may convert light or electromagnetic radiation sensed by one or more image capture sensors into information, such as a digital image or a bitmap comprising a set of pixels. Each pixel may have chrominance and/or luminance components that represent the intensity and/or color of light or electromagnetic radiation. In general, image capture devices 102 and image capture circuitry 103 may be part of a PAAV vision system used to gather information about a vehicle pathway 106. Image capture devices 102 may, for instance, send image capture information to computing device 116 via image capture circuitry 103. In some example approaches, image capture devices 102 capture lane markings, centerline markings, edge of roadway or shoulder markings, as well as the general shape of the vehicle pathway 106. The general shape of a vehicle pathway 106 may include turns, curves, incline, decline, widening, narrowing or other characteristics. Image capture devices 102 may have a fixed field of view or may have an adjustable field of view. An image capture device with an adjustable field of view may be configured to pan left and right, up and down relative to PAAV 110 as well as be able to widen or narrow focus. In some examples, image capture devices 102 may include a first lens and a second lens.

Image capture devices 102 may include one or more image capture sensors and one or more illumination sources 104. In some examples, image capture devices 102 may include image capture sensors and light sources in a single integrated device. In other examples, image capture sensors or illumination sources 104 may be separate from or otherwise not integrated in image capture devices 102. As described above, PAAV 110 may include illumination sources 104 separate from image capture devices 102. Examples of image capture sensors within image capture devices 102 may include semiconductor charge-coupled devices (CCD) or active pixel sensors in complementary metal-oxide-semiconductor (CMOS) or N-type metal-oxide-semiconductor (NMOS, Live MOS) technologies. Digital sensors include flat panel detectors. In one example, image capture devices 102 includes at least two different sensors for detecting light in two different wavelength spectrums.

In some examples, one or more illumination sources 104 include a first source of radiation and a second source of radiation. In some embodiments, the first source of radiation emits radiation in the visible spectrum, and the second source of radiation emits radiation in the near infrared spectrum. In other embodiments, the first source of radiation and the second source of radiation emit radiation in the near infrared spectrum. As shown in FIG. 1 one or more illumination sources 104 may emit radiation in the near infrared spectrum.

In some examples, image capture devices 102 captures frames at 50 frames per second (fps). Other examples of frame capture rates include 60, 30 and 25 fps. It should be apparent to a skilled artisan that frame capture rates are dependent on application and different rates may be used, such as, for example, 100 or 200 fps. Factors that affect required frame rate are, for example, size of the field of view (e.g., lower frame rates can be used for larger fields of view, but may limit depth of focus), and vehicle speed (higher speed may require a higher frame rate).

In some examples, image capture devices 102 may include more than one channel. The channels may be optical channels. The two optical channels may pass through one lens onto a single sensor. In some examples, image capture devices 102 includes at least one sensor, one lens and one band pass filter per channel. The band pass filter permits the transmission of multiple near infrared wavelengths to be received by the single sensor. The at least two channels may be differentiated by one of the following: (a) width of band (e.g., narrowband or wideband, wherein narrowband illumination may be any wavelength from the visible into the near infrared); (b) different wavelengths (e.g., narrowband processing at different wavelengths can be used to enhance features of interest, such as, for example, an enhanced sign of this disclosure, while suppressing other features (e.g., other objects, sunlight, headlights); (c) wavelength region (e.g., broadband light in the visible spectrum and used with either color or monochrome sensors); (d) sensor type or characteristics; (e) time exposure; and (f) optical components (e.g., lensing).

In some examples, image capture devices 102A and 102B may include an adjustable focus function. For example, image capture device 102B may have a wide field of focus that captures images along the length of vehicle pathway 106, as shown in the example of FIG. 1. Computing device 116 may control image capture device 102A to shift to one side or the other of vehicle pathway 106 and narrow focus to capture the image of pathway article 108, or of other features along vehicle pathway 106. The adjustable focus may be physical, such as adjusting a lens focus, or may be digital, similar to the facial focus function found on desktop conferencing cameras. In the example of FIG. 1, image capture devices 102 may be communicatively coupled to computing device 116 via image capture circuitry 103. Image capture circuitry 103 may receive image information from the plurality of image capture devices, such as image capture devices 102, perform image processing, such as filtering, amplification and the like, and send the image information to computing device 116.

Other components of PAAV 110 that may communicate with computing device 116 may include mobile device interface 112 and communication unit 214. In some examples, image capture circuitry 103, mobile device interface 112, and communication unit 214 may be separate from computing device 116 and in other examples may be a component of computing device 116.

Mobile device interface 112 may include a wired or wireless connection to a smartphone, tablet computer, laptop computer or similar device. In some examples, computing device 116 may communicate via mobile device interface 112 for a variety of purposes such as receiving traffic information, an address of a desired destination or other purposes. In some examples computing device 116 may communicate to external networks 114, e.g. the cloud, via mobile device interface 112. In other examples, computing device 116 may communicate with external networks via communication units 214.

One or more communication units 214 of computing device 116 may communicate with external devices by transmitting and/or receiving data. For example, computing device 116 may use communication units 214 to transmit and/or receive radio signals on a radio network such as a cellular radio network or other networks, such as network 114. In some examples communication units 214 may transmit and receive messages and information to other vehicles, such as information interpreted from enhanced pathway article 108. In some examples, communication units 214 may transmit and/or receive satellite signals on a satellite network such as a Global Positioning System (GPS) network.

In the example of FIG. 1, computing device 116 includes vehicle control component 144, user interface (UI) component 124, interpretation component 118 and security component 120. Components 118, 144, 124 and 120 may perform operations described herein using software, hardware, firmware, or a mixture of both hardware, software, and firmware residing in and executing on computing device 116 and/or at one or more other remote computing devices, such as computing device 134. In some examples, components 118, 144, 124 and 120 may be implemented as hardware, software, and/or a combination of hardware and software.

In some example approaches, computing device 116 may execute components 118, 124, 120 and 144 with one or more processors. Computing device 116 may execute any of components 118, 124, 120 and 144 as or within a virtual machine executing on underlying hardware. Components 118, 124, 120 and 144 may be implemented in various ways. For example, any of components 118, 124, 120 and 144 may be implemented as a downloadable or pre-installed application or “app.” In another example, any of components 118, 124, 120 and 144 may be implemented as part of an operating system of computing device 116. Computing device 116 may further include inputs from sensors not shown in FIG. 1 such as engine temperature sensor, speed sensor, tire pressure sensor, air temperature sensors, an inclinometer, accelerometers, light sensor, and similar sensing components.

UI component 124 may include any hardware or software for communicating with a user of PAAV 110. In some examples, UI component 124 may include outputs to a user such as displays, such as a display screen, indicator or other lights, audio devices to generate notifications or other audible functions. UI component 124 may also include inputs such as knobs, switches, keyboards, touch screens or similar types of input devices.

Vehicle control component 144 may include for example, any circuitry or other hardware, or software that may adjust one or more functions of the vehicle. Some examples include adjustments to change a speed of the vehicle, change the status of a headlight, changing a damping coefficient of a suspension system of the vehicle, apply a force to a steering system of the vehicle or change the interpretation of one or more inputs from other sensors. For example, an IR capture device may determine an object near the vehicle pathway has body heat and change the interpretation of a visible spectrum image capture device from the object being a non-mobile structure to a possible large animal that could move into the pathway. Vehicle control component 144 may further control the vehicle speed based on these changes. In some examples, the computing device 116 initiates the determined adjustment for one or more functions of the PAAV based on the machine-perceptible information in conjunction with a human operator that alters one or more functions of the PAAV based on the human-perceptible information.

Interpretation component 118 may receive infrastructure information about vehicle pathway 106 and pathway articles 108 and determine one or more characteristics of vehicle pathway 106. For example, interpretation component 118 may use information captured from pathway articles 108 by image capture devices 102 and/or information from other systems of PAAV 110 to make determinations about characteristics of vehicle pathway 106. As described below, in some examples, interpretation component 118 may transmit such determinations to vehicle control component 144, which may control PAAV 110 based on the information received from interpretation component 118. In other examples, computing device 116 may use information from interpretation component 118 to generate notifications for a user of PAAV 110, e.g., notifications that indicate a characteristic or condition of vehicle pathway 106.

Security component 120 may also receive infrastructure information about vehicle pathway 106 and pathway articles 108 and may determine one or more characteristics of PAAV 110. For example, security component 120 may use information captured from pathway articles 108 by image capture devices 102 and/or information from other systems of PAAV 110 to validate vehicle operation parameters indicated (and in some cases measured) by other systems in PAAV 110. As described below, in some examples, security component 120 may transmit such validations to vehicle control component 144, which may communicate with computing device 134 and which may control PAAV 110 based on the information received from security component 120. In some example approaches, computing device 116 may use validation information from security component 120 to perform one or more actions, such as to generate notifications for a user of PAAV 110, e.g., notifications that indicate a validation issue corresponding to a characteristic or condition of PAAV 110, modify an operation of PAAV 110, and output notifications to an administrator of the pathway.

In one example approach, for instance, PAAV 110 includes a speedometer. Computing device 116 receives velocity information from the sensors associated with the speedometer. At the same time, security component 120 calculates the speed of PAAV 110 based on pathway articles 108 as captured, for instance, by image capture devices 102 or acoustic sensors of PAAV 110 (not shown in FIG. 1). Computing device 116 then compares the vehicle speed of PAAV 110 determined based on the velocity information from the sensors associated with the speedometer to the vehicle speed of the PAAV 110 determined based on markings embedded in pathway articles 108, and computing device 116 performs one or more actions if the two vehicle speeds differ by more than a threshold value. For example, computing device 116 may register a problem in determining vehicle speed and generate a failure warning. Computing device 116 and/or computing device 134 may then act to isolate and resolve the source of the error in determining vehicle speed. If the determined speeds do not differ by more than the threshold value, the vehicle speed determination of the PAAV 110 is validated.

In one example approach, security component 120 relies on pathway articles 108 to provide the trusted points of reference used to validate PAAV 110 operation. In one such example approach, system 100 achieves this by comparing parameters determined based on points of reference external to PAAV 110 to the internal representation of those same parameters indicated by other sub-systems of the PAAV 110, which may generate such parameters based on measurements from PAAV 110 sensors (e.g., speedometer, GPS unit). The parameters may include parameters such as vehicle proximity, orientation, velocity and the relative direction of pathway articles 108 and, possibly, other external trusted points of reference to the vehicle. Such an approach leverages the fixed infrastructure of, for instance, a traffic control system to provide trusted points of reference used to validate connected and autonomous vehicle behavior in detecting environmental conditions, detecting driving conditions, detecting a driver's intent and authenticating infrastructure as genuine.

In one example approach, system 100 compares and contrasts information derived from external trusted points of reference with information on the actual behavior of the vehicle and the intentions of the driver as determined by onboard computing device 116. The external trusted points of reference provide out of band authentication.

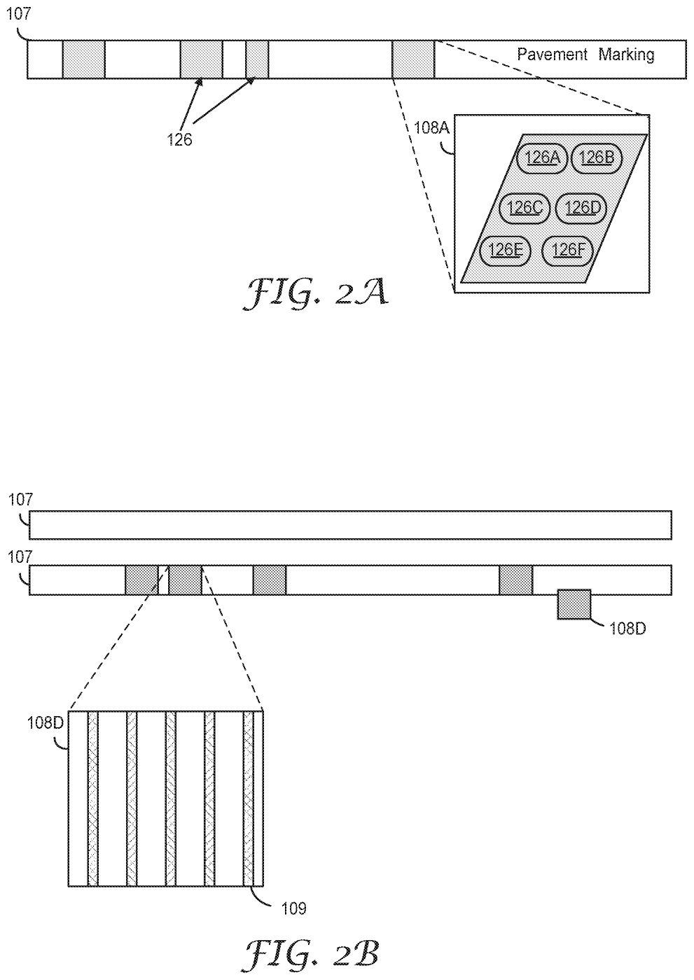

FIGS. 2A and 2B are conceptual diagrams showing top views of a pathway article in which pavement markers 108A or 108B are placed at defined intervals in pavement marking material 107, in accordance with techniques of this disclosure. One representative pavement marking material is 3M™ Stamark™ Pavement Marking Tape Series 380. In one example approach, pavement markers 108A or 108B are integrated into pavement marking material 107 and are installed as part of the pavement marking process. In other example approaches, pavement markers 108A or 108B are deployed as material patches to the pathway, such as to existing road markings, as shown in FIG. 2B.

In one example approach, pavement markers 108A and 108B take the form of embedded codes, such as within optically active markers integrated into the road markings, for example. In one example approach, the embedded code includes, at least in part, a barcode or QR code. In another example approach, the embedded code may take the form of any number of coding structures used to convey information. The pathway articles in the form of pavement markings are externally trusted points of reference to provide out of band authentication that can take the form of embedded codes, optically active markers integrated into the road markings for example. The ‘code’ does not have to be limited to a traditional barcode, for example it could be an acoustic signature or a pattern detected by the vehicle at regular intervals within a single length of pavement marking material

Pathway articles 108 in FIG. 1 may include one or more article message components 126A-126F (collectively “article message 126”). Each article message 126 may include components or features that provide information on one or more characteristics of vehicle pathway 106. Article message 126 may, for instance, include primary information (interchangeably referred to herein as human-perceptible information) that indicates general information about vehicle pathway 106. Article message 126 may also include additional information (interchangeably referred to herein as machine-perceptible information) that may be configured to be interpreted by a PAAV 110.

In one example approach, article message components 126A-126F include a graphical symbol 126A, a graphical enhancement 126B, a machine readable fiducial marker 126C (also referred to as fiducial tag 126C), article border information 126D, one or more security elements 126E and a polarization area 126F. Fiducial tag 126C may represent additional information about characteristics of vehicle pathway 106, such as the radius of the impending curve indicated by graphical symbol 126A or a scale factor for the shape of graphical symbol 126A. In some examples, fiducial tag 126C may indicate to computing device 116 that pathway article 108 is an enhanced pathway article rather than a conventional pathway article. In other examples, fiducial tag 126C may act as a security element that indicates enhanced pathway article 108 is not a counterfeit.

In other examples, other portions of article message 126 may indicate to computing device 116 that a pathway article is an enhanced pathway article. For example, according to aspects of this disclosure, article message 126 may include a change in polarization in area 126F. In one such example, computing device 116 may identify the change in polarization in area 126F and determine that article message 126 includes additional information in area 126F regarding vehicle pathway 106. As described above in relation to fiducial tag 126C, thickened portion 126B, border information 126D, and/or area 126F may include detailed information about, for instance, characteristics of vehicle pathway 106 or of traffic on vehicle pathway 106. For example, border information 126D may include information such as the number of curves to the left and right, the radius of each curve and the distance between each curve.

In accordance with techniques of this disclosure, enhanced pathway article 108 may further include article message components such as one or more security elements 126E, separate from fiducial tag 126C. In some examples, security elements 126E may be any portion of article message 126 that is printed, formed, or otherwise embodied on pathway article 108 that facilitates the detection of counterfeit pathway articles.

As described above for area 126F, some components of article message 126 may only be detectable outside the visible light spectrum. This may have advantages of avoiding interfering with a human operator interpreting pathway article 108, providing additional security. The non-visible components of article message 126 may be placed with area 126F, security elements 126E and fiducial tag 126C.

Pavement markers 108A, 108B may include other types of information encoding. In one example approach, for instance, pavement marking material 107 is embossed with a pattern that generates an acoustic signature when a tire rolls over the pattern. In some example approaches, as is shown in FIG. 2B, the embedded code is an acoustic signature or an acoustic pattern detected as a vehicle's tires pass over ribs 109 in an acoustic pavement marker 108D. In some such example approaches, acoustic pavement markers 108D are placed at predefined within a single length of pavement marking material 107. The embedded code may, therefore, be a series of acoustic readings detected at known intervals within a single length of pavement marking material 107, as shown in FIG. 2B, or across two or more lengths of pavement marking material 107.

In the example approach of FIG. 2B, each of the acoustic pavement markers 108D is installed as a patch onto one or more pieces of pavement marking material 107. In some example approaches, the patches may take the form of a texturized patch that generates a combination of acoustic emissions when the wheels of the vehicle strike the road marking to generate a unique acoustic signature. The acoustic signal is generated by the partially inelastic collision and vibration of the vehicle when in contact with the passive road-marking.

In one example approach, as noted above and as shown in FIG. 2B, acoustic pavement marker 108D includes a series of ribs 109. In another example approach acoustic pavement markers 108D are formed in the existing pavement marking material by forming indents in the pavement marking materials and/or the pavement beneath the pavement marking material. In some such example approaches, each of the ribbed or indented markings provides a unique signature, sufficiently diverse, so as to support the clear and reliable determination and communication of both contextual information and vehicle associated events.

In one example approach, autonomous vehicles rely on the acoustic signals generated by the interaction of the vehicle with the acoustic pavement markers 108D to supply trusted points of reference for cyber security and safety applications. In addition, acoustic signals may include information needed for real time communication between the vehicle and the traffic infrastructure, or data to be harvested by the vehicle and shared with other vehicles. The generation of these acoustic alerts and messages, may, for instance, provide critical information about the pathway context, the vehicle's journey, and the safety of the driver. Pathway context may include a zone of vehicle operation, such as a pedestrian zone, a construction zone, a freeway, a residential area, a parking lot, and so forth.

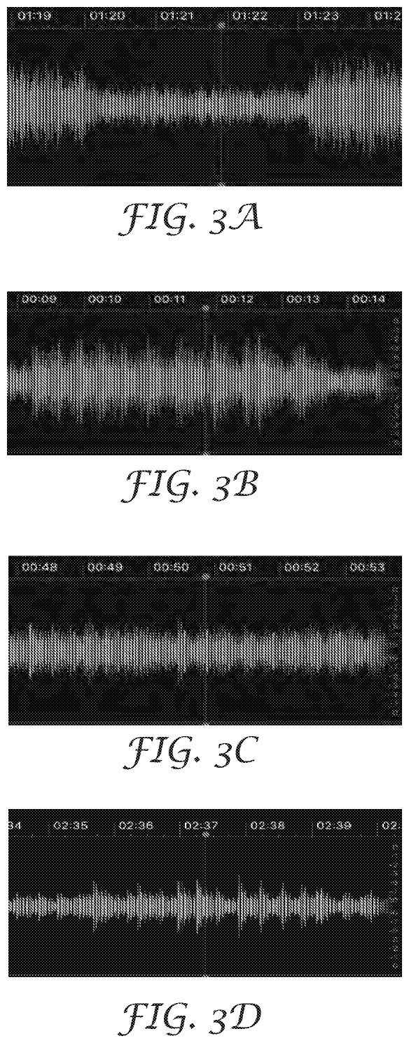

FIGS. 3A-3D illustrate representative acoustic signals, in accordance with techniques of this disclosure. FIG. 3A illustrates an example transition in an acoustic signature due to, for instance, departing from the vehicle's current lane. FIG. 3B illustrates example transitions in an acoustic signature due to, for instance, the vehicle encountering ribs or indents as it moves onto a hard should before coming to rest. FIG. 3C illustrates an example acoustic signature due to, for instance, entering a “Keep Out” zone. FIG. 3D illustrates an example transition in an acoustic signature due to, for instance, encountering road studs when drifting out of a current lane. Each of these signatures may be used to provide a trusted point of reference through a pathway article 108. Any of these signatures may be used to identify an externally trusted point of reference and may represent an acoustic signature of any of pathway articles 108 of FIG. 1.

Returning to the discussion of FIG. 1, non-visible components in FIG. 1 are described for illustration purposes as being formed by different areas that either retroreflect or do not retroreflect light, non-visible components in FIG. 1 may be printed, formed, or otherwise embodied in a pathway article using any light reflecting technique in which information may be determined from non-visible components. For instance, non-visible components may be printed using visibly-opaque, infrared-transparent ink and/or visibly-opaque, infrared-opaque ink. In some examples, non-visible components may be placed on pathway article 108 by employing polarization techniques, such as right circular polarization, left circular polarization or similar techniques.

According to aspects of this disclosure, in operation, interpretation component 118 may receive an image of pathway article 108 via image capture circuitry 103 and interpret information from article message 126. For example, interpretation component 118 may interpret fiducial tag 126C and determine that (a) pathway article 108 contains additional, machine readable information and (b) that pathway article 108 is not counterfeit.

Interpretation unit 118 may determine one or more characteristics of vehicle pathway 106 from the primary information as well as the additional information. In other words, interpretation unit 118 may determine first characteristics of the vehicle pathway from the human-perceptible information on the pathway article 108, and then determine second characteristics from the machine-perceptible information. For example, interpretation unit 118 may determine physical properties, such as the approximate shape of an impending set of curves in vehicle pathway 106 by interpreting the shape of arrow 126A. The shape of arrow 126A defining the approximate shape of the impending set of curves may be considered the primary information. The shape of arrow 126A may also be interpreted by a human occupant of PAAV 110.

Interpretation component 118 may also determine additional characteristics of vehicle pathway 106 by interpreting other machine-readable portions of article message 126. For example, by interpreting border information 126D and/or area 126F, interpretation component 118 may determine vehicle pathway 106 includes an incline along with a set of curves. Interpretation component 118 may signal computing device 116, which may cause vehicle control component 144 to prepare to increase power to maintain speed up the incline. Additional information from article message 126 may cause additional adjustments to one or more functions of PAAV 110. Interpretation component 118 may determine other characteristics, such as a change in road surface. Computing device 116 may determine characteristics of vehicle pathway 106 require a change to the vehicle suspension settings and cause vehicle control component 144 to perform the suspension setting adjustment. In some examples, interpretation component 118 may receive information on the relative position of lane markings to PAAV 110 and send signals to computing device 116 that cause vehicle control component 144 to apply a force to the steering to center PAAV 110 between the lane markings.

In one example approach, information stored as article messages 126 in pathway articles 108 are just one aspect of the information that computing device 116, or a human operator, may consider when operating a vehicle. Other information may include information from other sensors, such as radar or ultrasound distance sensors, wireless communications with other vehicles, lane markings on the vehicle pathway captured from image capture devices 102, information from GPS, and the like. Computing device 116 may consider the various inputs (p) and consider each with a weighting value, such as in a decision equation, as local information to improve the decision process. One possible decision equation may include:

D=w1*p1+w2*p2+ . . . wn*pn+wES*pES

where the weights (w1−wn) may be a function of the information received from the enhanced sign (pES). In the example of a construction zone, an enhanced sign may indicate a lane shift from the construction zone. Therefore, computing device 116 may de-prioritize signals from lane marking detection systems when operating the vehicle in the construction zone.

In some examples, PAAV 110 may be a test vehicle that may determine one or more characteristics of vehicle pathway 106 and may include additional sensors as well as components to communicate to a construction device such as construction device 138. As a test vehicle, PAAV 110 may be autonomous, remotely controlled, semi-autonomous or manually controlled. One example application may be to determine a change in vehicle pathway 106 near a construction zone. Once the construction zone workers mark the change with barriers, traffic cones or similar markings, PAAV 110 may traverse the changed pathway to determine characteristics of the pathway. Some examples may include a lane shift, closed lanes, detour to an alternate route and similar changes. The computing device onboard the test device, such as computing device 116 onboard PAAV 110, may assemble the characteristics of the vehicle pathway into data that contains the characteristics, or attributes, of the vehicle pathway.

Computing device 134 may receive a printing specification that defines one or more properties of pathway article 108. For example, computing device 134 may receive printing specification information included in the MUTCD from the U.S. DOT, or similar regulatory information found in other countries, that define the requirements for size, color, shape and other properties of pathway articles used on vehicle pathways. A printing specification may also include properties of manufacturing the barrier layer, retroreflective properties and other information that may be used to generate a pathway article. Machine-perceptible information may also include a confidence level of the accuracy of the machine-perceptible information. For example, a pathway marked out by a drone may not be as accurate as a pathway marked out by a test vehicle. Therefore, the dimensions of a radius of curvature, for example, may have a different confidence level based on the source of the data. The confidence level may impact the weighting of the decision equation described above.

Computing device 134 may generate construction data to form the article message on an optically active device, which will be described in more detail below. The construction data may be a combination of the printing specification and the characteristics of the vehicle pathway. Construction data generated by computing device 134 may cause construction device 138 to dispose the article message on a substrate in accordance with the printing specification and the data that indicates at least one characteristic of the vehicle pathway.

In one example approach, pavement markers 108A and 108B may include reflective, non-reflective, and/or retroreflective sheets applied to a base surface. An article message 126, such as but not limited to characters, images, and/or any other information, may be printed, formed, or otherwise embodied on the pathway article 108. In one example approach, reflective, non-reflective, and/or retroreflective sheets may be applied to a base surface using one or more techniques and/or materials including but not limited to: mechanical bonding, thermal bonding, chemical bonding, or any other suitable technique for attaching retroreflective sheet to a base surface. A base surface may include any surface of an object (such as described above, e.g., an aluminum plate) to which the reflective, non-reflective, and/or retroreflective sheet may be attached. An article message 126 may be printed, formed, or otherwise embodied on the sheeting using any one or more of an ink, a dye, a thermal transfer ribbon, a colorant, a pigment, and/or an adhesive coated film. In some examples, content is formed from or includes a multi-layer optical film, a material including an optically active pigment or dye, or an optically active pigment or dye.

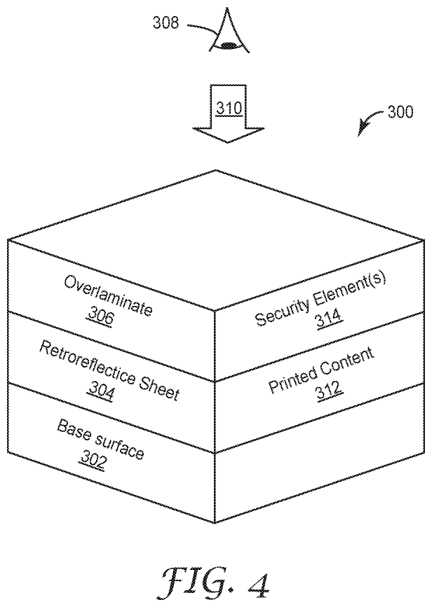

FIG. 4 is a conceptual diagram of a cross-sectional view of a pathway article in accordance with techniques of this disclosure. In some examples, such as for pavement markers or for an enhanced sign, a pathway article 108 may comprise multiple layers. For purposes of illustration in FIG. 4, a pathway article 300 may include a base surface 302. Base surface 302 may be an aluminum plate, pavement marking material or any other rigid, semi-rigid, or flexible surface. Retroreflective sheet 304 may be a retroreflective sheet as described in this disclosure. A layer of adhesive (not shown) may be disposed between retroreflective sheet 304 and base surface 302 to adhere retroreflective sheet 304 to base surface 302.

Pathway article may include an overlaminate 306 that is formed or adhered to retroreflective sheet 304. Overlaminate 306 may be constructed of a visibly-transparent, infrared opaque or infrared absorbing material, such as but not limited to multilayer optical film as disclosed in U.S. Pat. No. 8,865,293, which is expressly incorporated by reference herein in its entirety. In some examples, a film used in accordance with techniques of this disclosure may be infrared reflective. In some construction processes, retroreflective sheet 304 may be printed and then overlaminate 306 subsequently applied to reflective sheet 304. A viewer 308, such as a person or image capture device, may view pathway article 300 in the direction indicated by the arrow 310.

As described in this disclosure, in some examples, an article message 126 may be printed or otherwise included on a retroreflective sheet. In such examples, an overlaminate may be applied over the retroreflective sheet, but the overlaminate may not contain an article message. In the example of FIG. 4, visible portions 312 of the article message may be included in retroreflective sheet 304, but non-visible portions 314 of the article message may be included in overlaminate 306. In some examples, a non-visible portion may be created from or within a visibly-transparent, infrared opaque material that forms an overlaminate. European publication No. EP0416742 describes recognition symbols created from a material that is absorptive in the near infrared spectrum but transparent in the visible spectrum. Suitable near infrared absorbers/visible transmitter materials include dyes disclosed in U.S. Pat. No. 4,581,325. U.S. Pat. No. 7,387,393 describes license plates including infrared-blocking materials that create contrast on a license plate. U.S. Pat. No. 8,865,293 describes positioning an infrared-reflecting material adjacent to a retroreflective or reflective substrate, such that the infrared-reflecting material forms a pattern that can be read by an infrared sensor when the substrate is illuminated by an infrared radiation source. EP0416742 and U.S. Pat. Nos. 4,581,325, 7,387,393 and 8,865,293 are herein expressly incorporated by reference in their entireties. In some examples, overlaminate 306 may be etched with one or more visible or non-visible portions.

In some examples, if overlaminate includes non-visible portions 314 and retroreflective sheet 304 includes visible portions 312 of article message, an image capture device may capture two separate images, where each separate image is captured under a different lighting spectrum or lighting condition. For instance, the image capture device may capture a first image under a first lighting spectrum that spans a lower boundary of infrared light to an upper boundary of 900 nm. The first image may indicate which encoding units are active or inactive. The image capture device may capture a second image under a second lighting spectrum that spans a lower boundary of 900 nm to an upper boundary of infrared light. The second image may indicate which portions of the article message are active or inactive (or present or not present). Any suitable boundary values may be used. In some examples, multiple layers of overlaminate, rather than a single layer of overlaminate 306, may be disposed on retroreflective sheet 304. One or more of the multiple layers of overlaminate may have one or more portions of the article message. Techniques described in this disclosure with respect to the article message may be applied to any of the examples described in FIG. 4 with multiple layers of overlaminate.

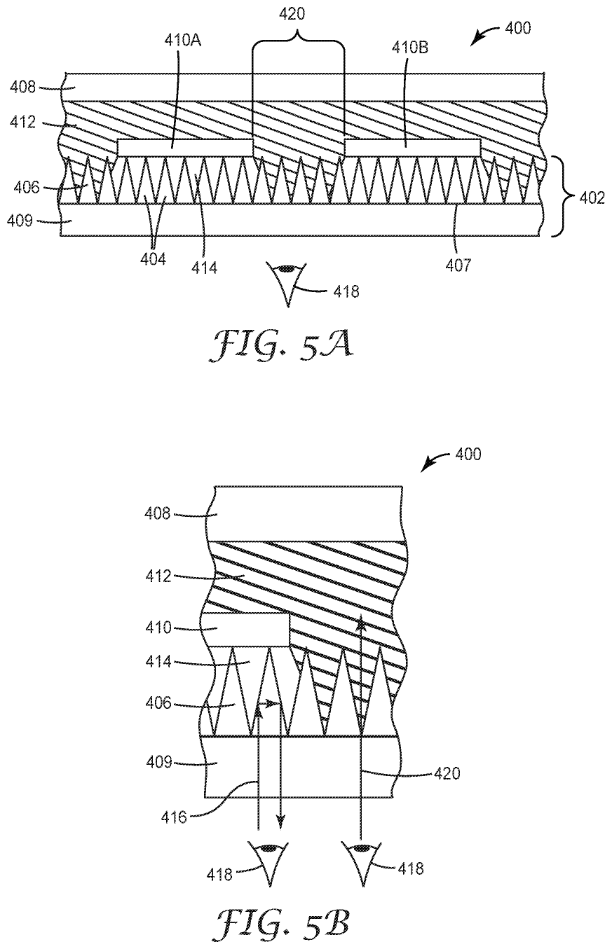

FIGS. 5A and 5B illustrate cross-sectional views of portions of an article message formed on a retroreflective sheet, in accordance with one or more techniques of this disclosure. In the example shown, retroreflective article 400 includes a retroreflective layer 402 including multiple cube corner elements 404 that collectively form a structured surface 406 opposite a major surface 407. The optical elements can be full cubes, truncated cubes, or preferred geometry (PG) cubes as described in, for example, U.S. Pat. No. 7,422,334, incorporated herein by reference in its entirety. The specific retroreflective layer 402 shown in FIGS. 5A and 4B includes a body layer 409, but those of skill will appreciate that some examples do not include an overlay layer. One or more barrier layers 410 are positioned between retroreflective layer 402 and conforming layer 412, creating a low refractive index area 414. Barrier layers 410 form a physical “barrier” between cube corner elements 404 and conforming layer 412. Barrier layer 410 can directly contact or be spaced apart from or can push slightly into the tips of cube corner elements 404. Barrier layers 410 have a characteristic that varies from a characteristic in one of (1) the areas 412 not including barrier layers (view line of light ray 416) or (2) another barrier layer 412. Exemplary characteristics include, for example, color and infrared absorbency.

In general, any material that prevents the conforming layer material from contacting cube corner elements 404 or flowing or creeping into low refractive index area 414 can be used to form the barrier layer Exemplary materials for use in barrier layer 410 include resins, polymeric materials, dyes, inks (including color-shifting inks), vinyl, inorganic materials, UV-curable polymers, multi-layer optical films (including, for example, color-shifting multi-layer optical films), pigments, particles, and beads. The size and spacing of the one or more barrier layers can be varied. In some examples, the barrier layers may form a pattern on the retroreflective sheet. In some examples, one may wish to reduce the visibility of the pattern on the sheeting. In general, any desired pattern can be generated by combinations of the described techniques, including, for example, indicia such as letters, words, alphanumerics, symbols, graphics, logos, or pictures. The patterns can also be continuous, discontinuous, monotonic, dotted, serpentine, any smoothly varying function, stripes, varying in the machine direction, the transverse direction, or both; the pattern can form an image, logo, or text, and the pattern can include patterned coatings and/or perforations. The pattern can include, for example, an irregular pattern, a regular pattern, a grid, words, graphics, images lines, and intersecting zones that form cells.

The low refractive index area 414 is positioned between (1) one or both of barrier layer 410 and conforming layer 412 and (2) cube corner elements 404. The low refractive index area 414 facilitates total internal reflection such that light that is incident on cube corner elements 404 adjacent to a low refractive index area 414 is retroreflected. As is shown in FIG. 5B, a light ray 416 incident on a cube corner element 404 that is adjacent to low refractive index layer 414 is retroreflected back to viewer 418. For this reason, an area of retroreflective article 400 that includes low refractive index layer 414 can be referred to as an optically active area. In contrast, an area of retroreflective article 400 that does not include low refractive index layer 414 can be referred to as an optically inactive area because it does not substantially retroreflect incident light. As used herein, the term “optically inactive area” refers to an area that is at least 50% less optically active (e.g., retroreflective) than an optically active area. In some examples, the optically inactive area is at least 40% less optically active, or at least 30% less optically active, or at least 20% less optically active, or at least 10% less optically active, or at least at least 5% less optically active than an optically active area.

Low refractive index layer 414 includes a material that has a refractive index that is less than about 1.30, less than about 1.25, less than about 1.2, less than about 1.15, less than about 1.10, or less than about 1.05. In general, any material that prevents the conforming layer material from contacting cube corner elements 404 or flowing or creeping into low refractive index area 414 can be used as the low refractive index material. In some examples, barrier layer 410 has sufficient structural integrity to prevent conforming layer 412 from flowing into a low refractive index area 414. In such examples, low refractive index area may include, for example, a gas (e.g., air, nitrogen, argon, and the like). In other examples, low refractive index area includes a solid or liquid substance that can flow into or be pressed into or onto cube corner elements 404. Exemplary materials include, for example, ultra-low index coatings (those described in PCT Patent Application No. PCT/US2010/031290), and gels.

The portions of conforming layer 412 that are adjacent to or in contact with cube corner elements 404 form non-optically active (e.g., non-retroreflective) areas or cells. In some examples, conforming layer 412 is optically opaque. In some examples conforming layer 412 has a white color.

In some examples, conforming layer 412 is an adhesive. Exemplary adhesives include those described in PCT Patent Application No. PCT/US2010/031290. Where the conforming layer is an adhesive, the conforming layer may assist in holding the entire retroreflective construction together and/or the viscoelastic nature of barrier layers 410 may prevent wetting of cube tips or surfaces either initially during fabrication of the retroreflective article or over time.

In some examples, conforming layer 412 is a pressure sensitive adhesive. The PSTC (pressure sensitive tape council) definition of a pressure sensitive adhesive is an adhesive that is permanently tacky at room temperature which adheres to a variety of surfaces with light pressure (finger pressure) with no phase change (liquid to solid). While most adhesives (e.g., hot melt adhesives) require both heat and pressure to conform, pressure sensitive adhesives typically only require pressure to conform. Exemplary pressure sensitive adhesives include those described in U.S. Pat. No. 6,677,030. Barrier layers 410 may also prevent the pressure sensitive adhesive from wetting out the cube corner sheeting. In other examples, conforming layer 412 is a hot-melt adhesive.

In some examples, a pathway article may use a non-permanent adhesive to attach the article message to the base surface. This may allow the base surface to be re-used for a different article message. Non-permanent adhesive may have advantages in areas such as roadway construction zones where the vehicle pathway may change frequently.

In the example of FIG. 5A, a non-barrier region 420 does not include a barrier layer, such as barrier layer 410. As such, light may reflect with a lower intensity than barrier layers 410A-410B. In some examples, non-barrier region 420 may correspond to an “active” security element 126E. For instance, the entire region or substantially all of image region 142A may be a non-barrier region 420. In some examples, substantially all of image region 142A may be a non-barrier region that covers at least 50% of the area of image region 142A. In some examples, substantially all of image region 142A may be a non-barrier region that covers at least 75% of the area of image region 142A. In some examples, substantially all of image region 142A may be a non-barrier region that covers at least 90% of the area of image region 142A. In some examples, a set of barrier layers (e.g., 410A, 410B) may correspond to an “inactive” security element 126E. In some such examples, an “inactive” security element 126E may have its entire region or substantially all of image region 142D filled with barrier layers. In some examples, substantially all of image region 142D may be a non-barrier region that covers at least 75% of the area of image region 142D. In some examples, substantially all of image region 142D may be a non-barrier region that covers at least 90% of the area of image region 142D. In the foregoing description of FIGS. 5A and 4B, with respect to security layers, in some examples, non-barrier region 420 may correspond to an “inactive” security element while an “active” security element may have its entire region or substantially all of image region 142D filled with barrier layers.

Although the examples of FIGS. 4, 5A and 5B describe passivation island constructions, other retroreflective materials may be used. For instance, retroreflective materials may have seal films or beads. Pavement marking stripes may, for example, comprise beads as an optical element, but could also use cube corners, such as in raised pavement markings. In some examples, a laser in a construction device, such as construction device as described in this disclosure, may engrave the article message onto sheeting, which enables embedding markers specifically for predetermined meanings. Example techniques are described in U.S. Provisional Patent Application 62/264,763, filed on Dec. 8, 2015, which is hereby incorporated by reference in its entirety. In such examples, the portions of the article message in the pathway article can be added at print time, rather than being encoded during sheeting manufacture. In some examples, an image capture device may capture an image in which the engraved security elements or other portions of the article message 126 are distinguishable from other content of the pathway article 108. In some examples the article message may be disposed on the sheeting at a fixed location while in other examples, the article message may be disposed on the sheeting using a mobile construction device, as described above.

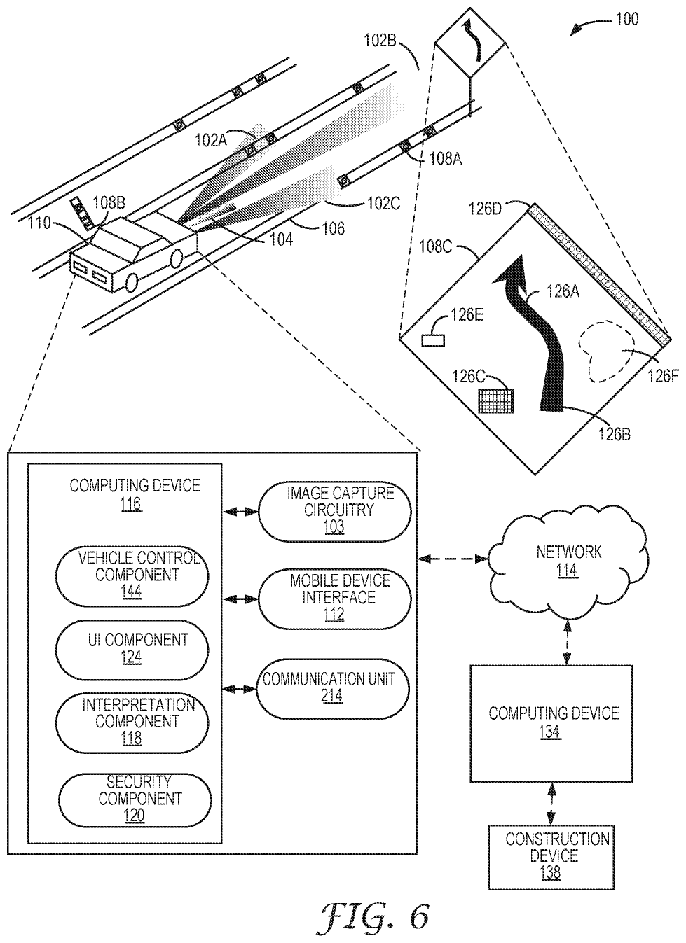

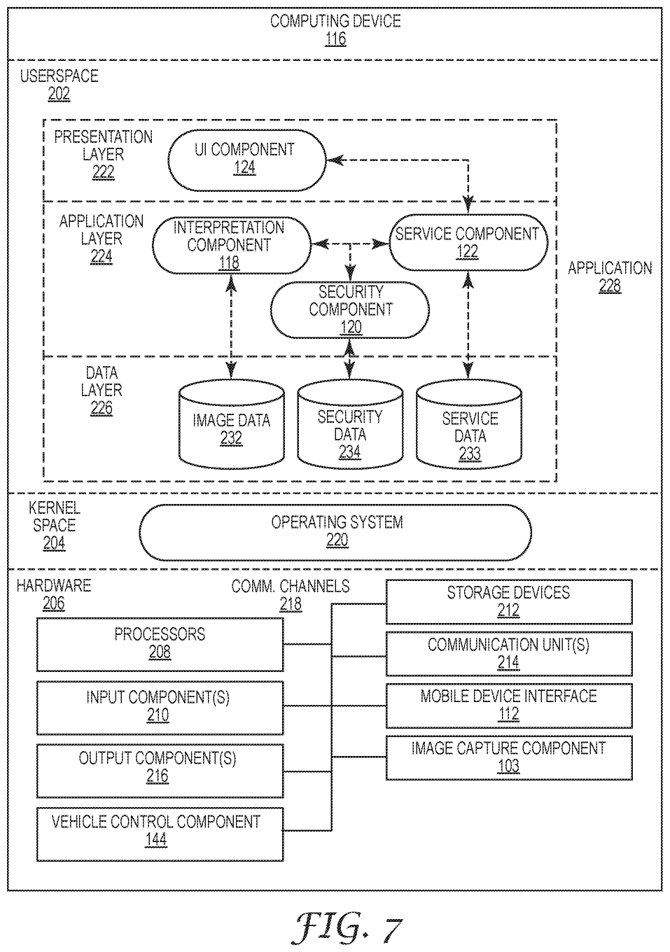

FIG. 6 is a block diagram illustrating another example system with pathway articles configured to be interpreted by driver assistance systems in accordance with techniques of this disclosure. In the example shown in FIG. 6, pathway articles 108 include enhanced pavement markers 108A and 108B and enhanced sign 108C. Enhanced sign 108C in FIG. 6 includes article message components 126A-126F (collectively “article message 126”). Article message 126 may include a plurality of components or features that provide information on one or more characteristics of a vehicle pathway. Article message 126 may include primary information (interchangeably referred to herein as human-perceptible information) that indicates general information about vehicle pathway 106. Article message 126 may include additional information (interchangeably referred to herein as machine-perceptible information) that may be configured to be interpreted by a PAAV.

In the example of FIG. 6, computing device 116 includes vehicle control component 144, user interface (UI) component 124, interpretation component 118 and security component 120. Components 118, 144, 124 and 120 may perform operations described herein using software, hardware, firmware, or a mixture of both hardware, software, and firmware residing in and executing on computing device 116 and/or at one or more other remote computing devices, such as computing device 134. In some examples, components 118, 144, 124 and 120 may be implemented as hardware, software, and/or a combination of hardware and software.

In some example approaches, computing device 116 may execute components 118, 124, 120 and 144 with one or more processors. Computing device 116 may execute any of components 118, 124, 120 and 144 as or within a virtual machine executing on underlying hardware. Components 118, 124, 120 and 144 may be implemented in various ways. For example, any of components 118, 124, 120 and 144 may be implemented as a downloadable or pre-installed application or “app.” In another example, any of components 118, 124, 120 and 144 may be implemented as part of an operating system of computing device 116. Computing device 116 may further include inputs from sensors not shown in FIG. 1 such as engine temperature sensor, speed sensor, tire pressure sensor, air temperature sensors, an inclinometer, accelerometers, light sensor, and similar sensing components.

In the example of FIG. 6, one component of article message 126 for enhanced sign 108C includes graphical symbol 126A. In the example shown in FIG. 6, graphical symbol 126A presents the general contour of an arrow representing primary information that describes a characteristic of vehicle pathway 106, such as an impending curve. Such primary information may be interpreted by both a human operator of PAAV 110 as well as computing device 116 onboard PAAV 110.

In some examples, according to aspects of this disclosure, article message 126 may include a machine readable fiducial marker 126C. The fiducial marker may also be referred to as a fiducial tag. Fiducial tag 126C may represent additional information about characteristics of pathway 106, such as the radius of the impending curve indicated by the arrow in graphical symbol 126A or a scale factor for the shape of arrow 126A. In some examples, fiducial tag 126C may indicate to computing device 116 that pathway article 108 is an enhanced sign 108C rather than a conventional sign. In other examples, fiducial tag 126C may act as a security element that indicates pathway article 108 is not a counterfeit.

In other examples, other portions of article message 126 may indicate to computing device 116 that a pathway article is an enhanced sign 108C. For example, according to aspects of this disclosure, article message 126 may include a change in polarization in area 126F. In this example, computing device 116 may identify the change in polarization and determine that article message 126 includes additional information regarding vehicle pathway 106.

In some example approaches, enhanced sign 108C further includes article message components such as one or more security elements 126E, separate from fiducial tag 126C. In some examples, security elements 126E may be any portion of article message 126 that is printed, formed, or otherwise embodied on enhanced sign 108 that facilitates the detection of counterfeit pathway articles.

Enhanced sign 108 may also include the additional information that represent characteristics of vehicle pathway 106 that may be printed, or otherwise disposed in locations that do not interfere with the graphical symbols, such as the arrow of graphical symbol 126A. For example, border information 126D may include additional information such as number of curves to the left and right, the radius of each curve and the distance between each curve. The example of FIG. 6 depicts border information 126D as along a top border of enhanced sign 108. In other examples, border information 126D may be placed along a partial border, or along two or more borders.

Similarly, enhanced sign 108 may include components of article message 126 that do not interfere with the graphical symbols by placing the additional information so it is detectable outside the visible light spectrum, such as area 126F. In addition, a thickened portion 126B may represent additional characteristics of vehicle pathway 106, such as that the impending curve has a 10% incline or decline. While thickened portion 126B may not be readily interpretable by a human operator, thickened portion 126B may be interpretable by computing device 116. In addition, border information 126D and area 126F may include detailed information about additional characteristics of vehicle pathway 106 or any other information.

As described above for area 126F, some components of article message 126 may only be detectable outside the visible light spectrum. This may have advantages of avoiding interfering with a human operator interpreting enhanced sign 108, providing additional security. The non-visible components of article message 126 may include area 126F, security elements 126E and fiducial tag 126C.

According to aspects of this disclosure, in operation, interpretation component 118 may receive an image of enhanced sign 108C via image capture circuitry 103 and interpret information from article message 126. For example, interpretation component 118 may interpret fiducial tag 126C and determine that (a) enhanced sign 108C contains additional, machine readable information and (b) that enhanced sign 108C is not counterfeit.

Interpretation unit 118 may determine one or more characteristics of vehicle pathway 106 from the primary information as well as the additional information in enhanced sign 108C. In other words, interpretation unit 118 may determine first characteristics of the vehicle pathway from the human-perceptible information on pathway article 108, and then determine secondary characteristics from the machine-perceptible information in pathway article 108. For example, interpretation unit 118 may determine physical properties, such as the approximate shape of an impending set of curves in vehicle pathway 106 by interpreting the shape of the arrow of graphical symbol 126A. In one example approach, the shape of the arrow equates to the approximate shape of the impending set of curves and may, therefore, be considered primary information. The shape of the arrow may also be interpreted by a human occupant of PAAV 110.

As in the discussion of FIG. 1 above, interpretation component 118 may also determine additional characteristics of vehicle pathway 106 by interpreting other machine-readable portions of article message 126. For example, by interpreting border information 126D and/or area 126F, interpretation component 118 may determine vehicle pathway 106 includes an incline along with a set of curves. Interpretation component 118 may signal computing device 116, which may cause vehicle control component 144 to prepare to increase power to maintain speed up the incline. Additional information from article message 126 may cause additional adjustments to one or more functions of PAAV 110. Interpretation component 118 may determine other characteristics, such as a change in road surface. Computing device 116 may determine characteristics of vehicle pathway 106 require a change to the vehicle suspension settings and cause vehicle control component 144 to perform the suspension setting adjustment. In some examples, interpretation component 118 may receive information on the relative position of lane markings to PAAV 110 and send signals to computing device 116 that cause vehicle control component 144 to apply a force to the steering to center PAAV 110 between the lane markings.

As in the discussion of FIG. 1 above, in FIG. 6, security component 120 may receive infrastructure information about vehicle pathway 106 and pathway articles 108 and may determine one or more characteristics of PAAV 110. For example, security component 120 may use information captured from enhanced sign 108C via image capture devices 102 and/or information from other systems of PAAV 110 to validate parameters measured by, for instance, interpretation component 118 or vehicle control component 144 in PAAV 110. As described below, in some examples, security component 120 may transmit such validations to vehicle control component 144, which may communicate with computing device 134 and which may control PAAV 110 based on the information received from security component 120. In some example approaches, computing device 116 may use information from security component 120 to generate notifications for a user of PAAV 110, e.g., notifications that indicate a validation issue corresponding to a characteristic or condition of PAAV 110.

As noted above, pathway articles 108 are just one source additional information that computing device 116, or a human operator, may consider when operating a vehicle. Other information may include information from other sensors, such as radar or ultrasound distance sensors, wireless communications with other vehicles, lane markings on the vehicle pathway captured from image capture devices 102, information from GPS, and the like. Computing device 116 may consider the various inputs (p) and consider each with a weighting value, such as in a decision equation, as local information to improve the decision process, as noted above. In the example of a construction zone, an enhanced sign 108C may indicate a lane shift from the construction zone. Therefore, computing device 116 may de-prioritize signals from lane marking detection systems when operating the vehicle in the construction zone.

In some examples, PAAV 110 may be a test vehicle that may determine one or more characteristics of vehicle pathway 106 and may include additional sensors as well as components to communicate to a construction device such as construction device 138. As a test vehicle, PAAV 110 may be autonomous, remotely controlled, semi-autonomous or manually controlled. One example application may be to determine a change in vehicle pathway 106 near a construction zone. Once the construction zone workers mark the change with signs, barriers, traffic cones or similar markings, PAAV 110 may traverse the changed pathway to determine characteristics of the pathway. Some examples may include a lane shift, closed lanes, detour to an alternate route and similar changes. The computing device onboard the test device, such as computing device 116 onboard PAAV 110, may assemble the characteristics of the vehicle pathway into data that contains the characteristics, or attributes, of the vehicle pathway.

FIG. 7 is a block diagram illustrating an example computing device, in accordance with one or more aspects of the present disclosure. FIG. 7 illustrates only one example of a computing device 116. Many other examples of computing device 116 may be used in other instances and may include a subset of the components included in example computing device 116 or may include additional components not shown example computing device 116 in FIG. 7.

In some examples, computing device 116 may be a server, tablet computing device, smartphone, wrist- or head-worn computing device, laptop, desktop computing device, or any other computing device that may run a set, subset, or superset of functionality included in application 228. In some examples, computing device 116 may correspond to vehicle computing device 116 onboard PAAV 110, depicted in FIGS. 1 and 6. In other examples, computing device 116 may also be part of a system or device that produces pathway articles 108 and correspond to computing device 134 depicted in FIGS. 1 and 6.

As shown in the example of FIG. 7, computing device 116 may be logically divided into user space 202, kernel space 204, and hardware 206. Hardware 206 may include one or more hardware components that provide an operating environment for components executing in user space 202 and kernel space 204. User space 202 and kernel space 204 may represent different sections or segmentations of memory, where kernel space 204 provides higher privileges to processes and threads than user space 202. For instance, kernel space 204 may include operating system 220, which operates with higher privileges than components executing in user space 202. In some examples, any components, functions, operations, and/or data may be included or executed in kernel space 204 and/or implemented as hardware components in hardware 206.

As shown in FIG. 2, hardware 206 includes one or more processors 208, input components 210, storage devices 212, communication units 214, output components 216, mobile device interface 112, image capture circuitry 103, and vehicle control component 144. Processors 208, input components 210, storage devices 212, communication units 214, output components 216, mobile device interface 112, image capture circuitry 103, illumination sources 104 and vehicle control component 144 may each be interconnected by one or more communication channels 218. Communication channels 218 may interconnect each of the components 103, 104, 112, 208, 210, 212, 214, 216, and 144 for inter-component communications (physically, communicatively, and/or operatively). In some examples, communication channels 218 may include a hardware bus, a network connection, one or more inter-process communication data structures, or any other components for communicating data between hardware and/or software.

One or more processors 208 may implement functionality and/or execute instructions within computing device 116. For example, processors 208 on computing device 116 may receive and execute instructions stored by storage devices 212 that provide the functionality of components included in kernel space 204 and user space 202. These instructions executed by processors 208 may cause computing device 116 to store and/or modify information, within storage devices 212 during program execution. Processors 208 may execute instructions of components in kernel space 204 and user space 202 to perform one or more operations in accordance with techniques of this disclosure. That is, components included in user space 202 and kernel space 204 may be operable by processors 208 to perform various functions described herein. Performing at least one operation includes performing one or more operations such as, for example, signaling an alert, generating a report, or sending a message.

One or more input components 210 of computing device 116 may receive input. Examples of input are tactile, audio, kinetic, and optical input, to name only a few examples. Input components 210 of computing device 116, in one example, include a mouse, keyboard, voice responsive system, video camera, buttons, control pad, microphone or any other type of device for detecting input from a human or machine. In some examples, input component 210 may be a presence-sensitive input component, which may include a presence-sensitive screen, touch-sensitive screen, etc.

One or more communication units 214 of computing device 116 may communicate with external devices by transmitting and/or receiving data. For example, computing device 116 may use communication units 214 to transmit and/or receive radio signals on a radio network such as a cellular radio network. In some examples, communication units 214 may transmit and/or receive satellite signals on a satellite network such as a Global Positioning System (GPS) network. Examples of communication units 214 include a network interface card (e.g. such as an Ethernet card), an optical transceiver, a radio frequency transceiver, a GPS receiver, or any other type of device that can send and/or receive information. Other examples of communication units 214 may include Bluetooth®, GPS, 3G, 4G, and Wi-Fi® radios found in mobile devices as well as Universal Serial Bus (USB) controllers and the like.

In some examples, communication units 214 may receive data that includes one or more characteristics of a vehicle pathway. In examples where computing device 116 is part of a vehicle, such as the PAAVs 110 depicted in FIGS. 1 and 6, communication units 214 may receive information about a pathway article from an image capture device. In other examples, such as examples where computing device 116 is part of a system or device that produces pathway articles 108, communication units 214 may receive data from a test vehicle, handheld device or other means that may gather data that indicates the characteristics of a vehicle pathway, as described above in FIGS. 1 and 6 and in more detail below. Computing device 116 may receive updated information, upgrades to software, firmware and similar updates via communication units 214.

One or more output components 216 of computing device 116 may generate output. Examples of output are tactile, audio, and video output. Output components 216 of computing device 116, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 216 may be integrated with computing device 116 in some examples.

In other examples, output components 216 may be physically external to and separate from computing device 116, but may be operably coupled to computing device 116 via wired or wireless communication. An output component may be a built-in component of computing device 116 located within and physically connected to the external packaging of computing device 116 (e.g., a screen on a mobile phone). In another example, a presence-sensitive display may be an external component of computing device 116 located outside and physically separated from the packaging of computing device 116 (e.g., a monitor, a projector, etc. that shares a wired and/or wireless data path with a tablet computer).

Hardware 206 may also include vehicle control component 144, in examples where computing device 116 is onboard a PAAV. Vehicle control component 144 may have the same or similar functions as the vehicle control components 144 described in relation to FIGS. 1 and 6.

One or more storage devices 212 within computing device 116 may store information for processing during operation of computing device 116. In some examples, storage device 212 is a temporary memory, meaning that a primary purpose of storage device 212 is not long-term storage. Storage devices 212 on computing device 116 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art.

Storage devices 212, in some examples, also include one or more computer-readable storage media. Storage devices 212 may be configured to store larger amounts of information than volatile memory. Storage devices 212 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 212 may store program instructions and/or data associated with components included in user space 202 and/or kernel space 204.

As shown in FIG. 7, application 228 executes in user space 202 of computing device 116. Application 228 may be logically divided into presentation layer 222, application layer 224, and data layer 226. Presentation layer 222 may include user interface (UI) component 228, which generates and renders user interfaces of application 228. Application 228 may include, but is not limited to: UI component 124, interpretation component 118, security component 120, and one or more service components 122. In one example approach, application layer 224 includes interpretation component 118, service component 122, and security component 120 while presentation layer 222 includes UI component 124.

In one example approach, security component 120 receives infrastructure information about vehicle pathway 106 and pathway articles 108 and may determine one or more characteristics of PAAV 110. For example, security component 120 may use information captured from pathway articles 108 by image capture devices 102 and/or information from other systems of PAAV 110 to validate parameters measured by other systems in PAAV 110. In some example approaches, security component 120 may transmit such validations to vehicle control component 144, which may communicate with computing device 134 and which may control PAAV 110 based on the information received from security component 120. In some example approaches, computing device 116 may use information from security component 120 to generate notifications via UI component 124 for a user of PAAV 110, e.g., notifications that indicate a validation issue corresponding to a characteristic or condition of PAAV 110.

In one example approach, security component 120 relies on pathway articles 108 to provide the trusted points of reference used to validate connected and autonomous vehicle behavior. In one such example approach, security component 120 operates conjunction with interpretation component 118 and computing device 134 to achieves this by comparing parameters determined based on points of reference external to PAAV 110 to the internal representation of those same parameters. The parameters may include parameters such as vehicle proximity, orientation, velocity and the relative direction of pathway articles 108 and, possibly, other external trusted points of reference to the vehicle. Such an approach leverages the fixed infrastructure of, for instance, a traffic control system to provide trusted points of reference used to validate connected and autonomous vehicle behavior in detecting environmental conditions, detecting driving conditions, detecting a driver's intent and authenticating infrastructure as genuine.

In one example approach, security component 120, operating with other components of computing device 116, compares and contrasts information derived from external trusted points of reference with information on the actual behavior of the vehicle and the intentions of the driver as determined by onboard computing device 116. The external trusted points of reference provide out of band authentication.

Data layer 226 may include one or more datastores. A datastore may store data in structure or unstructured form. Example datastores may be any one or more of a relational database management system, online analytical processing database, table, or any other suitable structure for storing data.

Security data 234 may include data specifying one or more validation functions and/or validation configurations. For instance, security data 234 may include information on pathway articles that may be used as external points of reference. Service data 233 may include any data to provide and/or resulting from providing a service of service component 122. For instance, service data may include information about pathway articles (e.g., security specifications), user information, or any other information. Image data 232 may include one or more images that are received from one or more image capture devices, such as image capture devices 102 described in relation to FIG. 1. In some examples, the images are bitmaps, Joint Photographic Experts Group images (JPEGs), Portable Network Graphics images (PNGs), or any other suitable graphics file formats.

In the example of FIG. 7, one or more of communication units 214 may receive, from an image capture device 102, an image of a pathway article 108 that includes an article message, such as article message 126 in FIG. 1 or FIG. 6. In some examples, UI component 124 or any one or more components of application layer 224 may receive the image of the pathway article 108 and store the image in image data 232.

In response to receiving the image, interpretation component 118 may determine that a pathway article 108 is an enhanced sign, such as enhanced sign 108C, or an enhanced pavement marker, such as pavement markers 108A or 108B. The pathway article may include at least one article message 126 that indicates one or more characteristics of a pathway for the PAAV. The article message may include primary, or human-perceptible information that indicates one or more first characteristics of the vehicle pathway. A pathway article may also include additional or machine-perceptible information that indicates the one or more additional characteristics of the vehicle pathway. In some examples the additional information may information include one or more of a predicted trajectory, an incline change, a change in width, a change in road surface, a defect in the pathway or other potential hazard, the location of other pathway articles, speed limit change, or any other information. An example of a predicted trajectory may include the shape of the vehicle pathway depicted by arrow in graphical symbol 126A of FIG. 6. As described above for area 126F, in some examples the additional information includes machine readable information that is detectable outside the visible light spectrum, such as by IR, a change in polarization or similar techniques.

Interpretation component 118 may determine one or more characteristics of a vehicle pathway and transmit data representative of the characteristics to other components of computing device 116, such as security component 120 and service component 122. Interpretation component 118 may determine the characteristics of the vehicle pathway indicate an adjustment to one or more functions of the vehicle. For example, the enhanced sign may indicate that the vehicle is approaching a construction zone and there is a change to the vehicle pathway. Computing device 116 may combine this information with other information from other sensors, such as image capture devices, GPS information, information from network 114 and similar information to adjust the speed, suspension or other functions of the vehicle through vehicle control component 144.

Similarly, computing device 116 may determine one or more conditions of the vehicle. Vehicle conditions may include a weight of the vehicle, a position of a load within the vehicle, a tire pressure of one or more vehicle tires, transmission setting of the vehicle and a powertrain status of the vehicle. For example, a PAAV with a large powertrain may receive different commands when encountering an incline in the vehicle pathway than a PAAV with a less powerful powertrain (i.e. motor).

Computing device may also determine environmental conditions in a vicinity of the vehicle. Environmental conditions may include air temperature, precipitation level, precipitation type, incline of the vehicle pathway, presence of other vehicles and estimated friction level between the vehicle tires and the vehicle pathway.

Computing device 116 may combine information from vehicle conditions, environmental conditions, interpretation component 118 and other sensors to determine adjustments to the state of one or more functions of the vehicle, such as by operation of vehicle control component 144, which may interoperate with any components and/or data of application 228. For example, interpretation component 118 may determine the vehicle is approaching a curve with a downgrade, based on interpreting an enhanced sign on the vehicle pathway. Computing device 116 may determine one speed for dry conditions and a different speed for wet conditions. Similarly, computing device 116 onboard a heavily loaded freight truck may determine one speed while computing device 116 onboard a sports car may determine a different speed.

In some examples, computing device 116 may determine the condition of the pathway by considering a traction control history of a PAAV. For example, if the traction control system of a PAAV is very active, computing device 116 may determine the friction between the pathway and the vehicle tires is low, such as during a snow storm or sleet.

Pathway articles 108 may include one or more security elements, such as security element 126E depicted in FIGS. 1 and 6, to help determine if the pathway article is counterfeit. Security is a concern with intelligent infrastructure to minimize the impact of hackers, terrorist activity or crime. For example, a criminal may attempt to redirect an autonomous freight truck to an alternate route to steal the cargo from the truck. An invalid security check may cause computing device 116 to give little or no weight to the information in the sign as part of the decision equation to control a PAAV.

As discussed above, for the machine-readable portions of the article message, the properties of security marks may include but are not limited to location, size, shape, pattern, composition, retroreflective properties, appearance under a given wavelength, or any other spatial characteristic of one or more security marks. Security component 120 may determine whether pathway article 108, such as, for instance, enhanced sign 108C is counterfeit based at least in part on determining whether the at least one symbol, such as the graphical symbol, is valid for at least one security element. As described in relation to FIGS. 1 and 6, security component 120 may include one or more validation functions and/or one or more validation conditions on which the construction of enhanced sign 108C is based. In some examples a fiducial marker, such as fiducial tag 126C may act as a security element. In other examples a pathway article may include one or more security elements such as security element 126E.

In FIG. 7, security component 120 determines, using a validation function based on the validation condition in security data 234, whether the pathway articles depicted in FIGS. 1 and 6 are counterfeit. Security component 120, based on determining that the security elements satisfy the validation configuration, generates data that indicates pathway articles such as enhanced sign 108C are authentic (e.g., not a counterfeit). If security elements and the article message in enhanced sign 108C did not satisfy the validation criteria, security component 120 may generate data that indicates pathway article is not authentic (e.g., counterfeit) or that the pathway article is not being read correctly.

A pathway article may not be read correctly if it is partially occluded or blocked, if the image is distorted or if the pathway article is damaged. For example, in heavy snow or fog, or along a hot highway subject to distortion from heat rising from the pathway surface, the image of the pathway article may be distorted. In another example, another vehicle, such as a large truck, or a fallen tree limb may partially obscure the pathway article. The security elements, or other components of the article message, may help determine if a pathway article such as a pavement marker 108A or 108B or an enhanced sign 108C is damaged. If the security elements are damaged or distorted, security component 120 may determine the pathway article is invalid.

For some examples of computer vision systems, such as may be part of PAAV 110, the pathway article may be visible in hundreds of frames as the vehicle approaches the enhanced sign. The interpretation of the enhanced sign may not necessarily rely on a single, successful capture image. At a far distance, the system may recognize, for instance, an enhanced sign 108C. As the vehicle gets closer, the resolution may improve and the confidence in the interpretation of the sign information may increase. The confidence in the interpretation may impact the weighting of the decision equation and the outputs from vehicle control component 144.

Service component 122 may perform one or more operations based on the data generated by security component 120 that indicates whether the pathway article is a counterfeit. Service component 122 may, for example, query service data 233 to retrieve a list of recipients for sending a notification or store information that indicates details of the image of the pathway article (e.g., object to which pathway article is attached, image itself, metadata of image (e.g., time, date, location, etc.)). In response to, for example, determining that the pathway article is a counterfeit, service component 122 may send data to UI component 124 that causes UI component 124 to generate an alert for display. UI component 124 may send data to an output component of output components 216 that causes the output component to display the alert.

Similarly, service component 122, or some other component of computing device 116, may cause a message to be sent through communication units 214 that the pathway article is damaged or counterfeit. In some examples the message may be sent to law enforcement, those responsible for maintenance of the vehicle pathway and to other vehicles, such as vehicles nearby the pathway article.

As with other portions of the article message, such as border information 126D and area 126F, in some examples, security component 120 may use both a visible light image captured under visible lighting and an IR light image captured under IR light to determine whether a pathway article is counterfeit. For instance, if counterfeiter places an obstructing material (e.g., opaque, non-reflective, etc.) over a security element to make it appear the opposite of what it is (e.g., make an active element appear inactive or vice versa), then security component 120 may determine from the visible light image that obstructing material has been added the pathway article. Therefore, even if the IR light image includes a valid configuration of security elements (due to the obstructing material at various locations), security component 120 may determine that the visible light image includes the obstructing material and is therefore counterfeit.

In some examples, security component 120 may determine one or more predefined image regions (e.g., stored in security data 234) that correspond to security elements for the pathway article. Security component 120 may inspect one or more of the predefined image regions within the image of the pathway article and determine, based at least in part on one or more pixel values in the predefined image regions, one or more values that represent the validation information.

In some examples, security component 120, when determining, based at least in part on one or more pixel values in the predefined image regions, one or more values that represent validation information, may further determine one or more values that represent the validation information based at least in part one whether the one or more predefined image regions of security elements are active or inactive. In some examples, security component 120 may determine the validation information that is detectable outside the visible light spectrum from the at least one security element further by determining the validation information based at least in part on at least one of a location, shape, size, pattern, composition of the at least one security element.

In some examples, security component 120 may determine whether the pathway article is counterfeit or otherwise invalid based on whether a combination of one or more symbols of the article message 126 and the validation information represent a valid association. Factors such as counterfeiting, damage, and rendering the article unreadable because of weather may lead to a pathway article being tagged as invalid.

The techniques of this disclosure may have an advantage in that the enhanced signs may be created using current printing technology and interpreted with baseline computer vision systems. The techniques of this disclosure may also provide advantages over barcode or similar systems in that a barcode reader may require a look-up database or “dictionary.” Some techniques of this disclosure, such as interpreting the shape of arrow shown in graphical symbol 126A in FIG. 5, may not require a look-up or other decoding to determine one or more characteristics of a vehicle pathway. The techniques of this disclosure include small changes to existing signs that may not change human interpretation, while taking advantage of existing computer vision technology to interpret an article message, such as a graphic symbol. Existing graphic symbols on many conventional signs may not depict the actual trajectory of the vehicle pathway. Graphical symbols on enhanced signs of this disclosure may describe actual pathway information, along with additional machine-readable information. In this manner, the techniques of this disclosure may help to ensure that autonomous, semi-autonomous and manually operated vehicles are responding to the same cues. The enhanced signs of this disclosure may also provide redundancy at the pathway level to cloud, GPS and other information received by PAAVs. Also, because the enhanced signs of this disclosure include small changes to existing signs, the techniques of this disclosure may be more likely to receive approval from regulatory bodies that approve signs for vehicle pathways.

Techniques of this disclosure may also have advantages of improved safety over conventional signs. For example, one issue with changes in vehicle pathways, such as a construction zone, is driver uncertainty and confusion over the changes. The uncertainty may cause a driver to brake suddenly, take the incorrect path or some other response. Techniques of this disclosure may ensure human operators have a better understanding of changes to vehicle pathway, along with the autonomous and semi-autonomous vehicles. This may improve safety, not only for drivers but for the construction workers, in examples of vehicle pathways through construction zones.

In some examples, application 228 and/or vehicle control component 144 may generate, using at least one infrastructure sensor, infrastructure data descriptive of infrastructure articles that are proximate to the vehicle. Application 228 and/or vehicle control component 144 may determine, based at least in part on the infrastructure data, a classification for a type of the infrastructure article. Application 228 and/or vehicle control component 144 may, in response to sending the classification to a remote computing device (e.g., computing device 134), receive an indication that the at least one infrastructure sensor is operating abnormally in comparison to infrastructure sensors of other vehicles. Application 228 and/or vehicle control component 144 may perform, based at least in part on the indication that the at least one infrastructure sensor operating abnormally, at least one operation. Example operations may include changing vehicle operation, outputting notifications to a driver, sending data to one or more other remote computing devices (e.g., computing devices near computing device 116, such as other vehicle computing devices), or any other suitable operation.

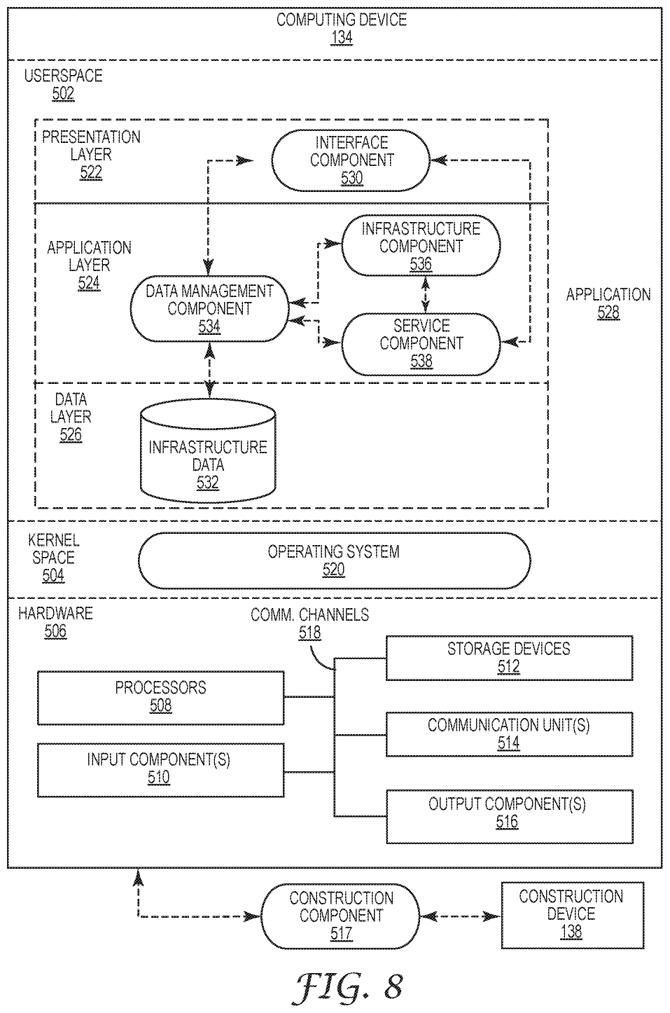

FIG. 8 is a block diagram illustrating another example computing device, in accordance with one or more aspects of the present disclosure. FIG. 8 illustrates only one example of a computing device, which in FIG. 8 is computing device 134 of FIGS. 1 and 6. Many other examples of computing device 134 may be used in other instances and may include a subset of the components included in example computing device 134 or may include additional components not shown, for example, in computing device 116 of FIG. 8. Computing device 134 may be a computing device (e.g., a server computing device) remote from computing device 116 in FIGS. 1 and 6.

In some examples, computing device 134 may be a server, tablet computing device, smartphone, wrist- or head-worn computing device, laptop, desktop computing device, or any other computing device that may run a set, subset, or superset of functionality included in application 228. In some examples, computing device 134 may correspond to computing device 134 depicted in FIGS. 1 and 6. In other examples, computing device 134 may also be part of a system or device that produces pathway articles 108.

As shown in the example of FIG. 8, computing device 134 may be logically divided into user space 502, kernel space 504, and hardware 506. Hardware 506 may include one or more hardware components that provide an operating environment for components executing in user space 502 and kernel space 504. User space 502 and kernel space 504 may represent different sections or segmentations of memory, where kernel space 504 provides higher privileges to processes and threads than user space 502. For instance, kernel space 504 may include operating system 520, which operates with higher privileges than components executing in user space 502. In some examples, any components, functions, operations, and/or data may be included or executed in kernel space 504 and/or implemented as hardware components in hardware 506.

As shown in FIG. 8, hardware 506 includes one or more processors 508, input components 510, storage devices 512, communication units 514, and output components 516. Processors 508, input components 510, storage devices 512, communication units 514, and output components 516 may each be interconnected by one or more communication channels 518. Communication channels 518 may interconnect each of the components 508, 510, 512, 514, and 516 for inter-component communications (physically, communicatively, and/or operatively). In some examples, communication channels 518 may include a hardware bus, a network connection, one or more inter-process communication data structures, or any other components for communicating data between hardware and/or software.

One or more processors 508 may implement functionality and/or execute instructions within computing device 134. For example, processors 508 on computing device 134 may receive and execute instructions stored by storage devices 512 that provide the functionality of components included in kernel space 504 and user space 502. These instructions executed by processors 508 may cause computing device 134 to store and/or modify information, within storage devices 512 during program execution. Processors 508 may execute instructions of components in kernel space 504 and user space 502 to perform one or more operations in accordance with techniques of this disclosure. That is, components included in user space 502 and kernel space 504 may be operable by processors 508 to perform various functions described herein.

One or more input components 510 of computing device 134 may receive input. Examples of input are tactile, audio, kinetic, and optical input, to name only a few examples. Input components 510 of computing device 134, in one example, include a mouse, keyboard, voice responsive system, video camera, buttons, control pad, microphone or any other type of device for detecting input from a human or machine. In some examples, input component 510 may be a presence-sensitive input component, which may include a presence-sensitive screen, touch-sensitive screen, etc.

One or more communication units 514 of computing device 134 may communicate with external devices by transmitting and/or receiving data. For example, computing device 134 may use communication units 514 to transmit and/or receive radio signals on a radio network such as a cellular radio network. In some examples, communication units 514 may transmit and/or receive satellite signals on a satellite network such as a Global Positioning System (GPS) network. Examples of communication units 514 include a network interface card (e.g. such as an Ethernet card), an optical transceiver, a radio frequency transceiver, a GPS receiver, or any other type of device that can send and/or receive information. Other examples of communication units 514 may include Bluetooth®, GPS, 3G, 4G, and Wi-Fi® radios found in mobile devices as well as Universal Serial Bus (USB) controllers and the like.

One or more output components 516 of computing device 134 may generate output. Examples of output are tactile, audio, and video output. Output components 516 of computing device 134, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 516 may be integrated with computing device 134 in some examples.

In other examples, output components 516 may be physically external to and separate from computing device 134, but may be operably coupled to computing device 134 via wired or wireless communication. An output component may be a built-in component of computing device 134 located within and physically connected to the external packaging of computing device 134 (e.g., a screen on a mobile phone). In another example, a presence-sensitive display may be an external component of computing device 134 located outside and physically separated from the packaging of computing device 134 (e.g., a monitor, a projector, etc. that shares a wired and/or wireless data path with a tablet computer).

One or more storage devices 512 within computing device 134 may store information for processing during operation of computing device 134. In some examples, storage device 512 is a temporary memory, meaning that a primary purpose of storage device 512 is not long-term storage. Storage devices 512 on computing device 134 may configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art.

Storage devices 512, in some examples, also include one or more computer-readable storage media. Storage devices 512 may be configured to store larger amounts of information than volatile memory. Storage devices 512 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 512 may store program instructions and/or data associated with components included in user space 502 and/or kernel space 504.

As shown in FIG. 8, application 528 executes in userspace 502 of computing device 134. Application 528 may be logically divided into presentation layer 522, application layer 524, and data layer 526. Application 528 may include, but is not limited to the various components and data illustrated in presentation layer 522, application layer 524, and data layer 526.

Data layer 526 may include one or more datastores. A datastore may store data in structure or unstructured form. Example datastores may be any one or more of a relational database management system, online analytical processing database, table, or any other suitable structure for storing data.

In accordance with techniques of this disclosure, application 528 may include interface component 530. In some examples, interface component 530 may generate output to a user or machine such as through a display, such as a display screen, indicator or other lights, audio devices to generate notifications or other audible functions, haptic feedback or any suitable output. In some examples, interface component 530 may receive any indications of input from user or machine, such as via knobs, switches, keyboards, touch screens, interfaces, or any other suitable input components.

In the example of FIG. 8, a set of vehicles may each communicate with application 528. Each respective vehicle in the set of vehicles may include at least one infrastructure sensor that generates infrastructure data 532 that is descriptive of infrastructure articles (e.g., pathway articles such as pavement markers 108A and B and sign 108C) that are proximate to the respective vehicle. Each vehicle may include one or more communication devices to transmit the infrastructure data to application 528.

Application 528 may receive and store infrastructure data 532 in data layer 526. In some examples, application 528 may receive, from the set of vehicles and via interface component, different sets of infrastructure data, including validation information, for specific infrastructure articles proximate to each respective vehicle of the set of vehicles. Data management component 534 may store, retrieve, create, and delete infrastructure data 532. In some examples, data management component 534 may perform pre-processing operations on data received from remote computing devices before it is stored as infrastructure In some examples, “proximate” may mean a distance between the vehicle and infrastructure article that is within a threshold distance. In some examples, the threshold distance may be a maximum distance that camera from a vehicle receives an image with a defined resolution. In some examples, the threshold distance is within a range of between zero and one mile. In some examples, the threshold distance may be within a range of 0-5 meters, 0-15 meters, 0-25 meters, 0-50 meters, or any other suitable range.

In some examples, infrastructure component 536 may determine, based at least in part on the different sets of infrastructure data for specific infrastructure articles from each respective vehicle of the set of vehicles, a quality metric for the infrastructure article. For instance, infrastructure component 536 may determine an average, median, mode, or any other aggregate or statistical value that collectively represents multiple samples of infrastructure data for the specific infrastructure article from multiple vehicles. In some examples, the quality metric may indicate a degree of quality of the article of infrastructure. In some examples, the quality metric may be a discrete value or a non-discrete value.

In some examples, infrastructure component 536 may include a model that generates a classification corresponding to a quality metric, where the classification is based at least in part on applying infrastructure data to the model. In some examples, infrastructure component 536 may perform this classification using machine learning techniques. Example machine learning techniques that may be employed to generate models can include various learning styles, such as supervised learning, unsupervised learning, and semi-supervised learning. Example types of algorithms include Bayesian algorithms, Clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbour (kNN), Learning Vector Quantization (LUQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

In some examples, a model is trained using supervised and/or reinforcement learning techniques. In some examples, infrastructure component 536 initially trains the model based on a training set of (1) sets of infrastructure data that correspond to (2) quality metrics. The training set may include a set of feature vectors, where each feature in the feature vector represents a value in a particular set of infrastructure data and a corresponding quality metric. Infrastructure component 536 may select a training set comprising a set of training instances, each training instance comprising an association between a set of infrastructure data and a corresponding quality metric. Infrastructure component 536 may, for each training instance in the training set, modify, based on a particular infrastructure data and corresponding particular quality metric of the training instance, the model to change a likelihood predicted by the model for the particular quality metric in response to subsequent infrastructure data applied to the model. In some examples, the training instances may be based on real-time or periodic data generated by vehicles.

In some examples, service component 538 may receive the quality metric from infrastructure component 536. Infrastructure component 536 may perform at least one operation based at least in part on the quality metric for the infrastructure article. Service component 538 may perform any number of operations and/or services as described in this disclosure. Example operations may include, but are not limited to, sending notifications or messages to one or more computing devices, logging or storing quality metrics, performing analytics on the quality metrics (e.g., identifying anomalies, event signatures, or the like), or performing any other suitable operations.

In some examples, application 528 may operate as a sign management system that inventories various properties of each respective infrastructure article and identifies particular infrastructure articles that require further inspection and/or replacement. For example, data management component 534 may store one or more properties of infrastructure articles in infrastructure data 532, such as but not limited to: infrastructure article type, infrastructure article location, infrastructure article unique identifier, last detected date of infrastructure article, infrastructure qualities (e.g., brightness, contrast, is damaged, is occluded, orientation, retroreflectance, color, or any other property indicating quality), infrastructure article installation date, authenticity or any other properties. In some examples, infrastructure component 536 and/or service component 538 may determine whether, based at least in part on one or more of the properties of infrastructure, the article of infrastructure should or must be inspected and/or replaced. Based at least in part on this determination, service component 538 may generate a notification to one or more computing devices (e.g., a custodian of a roadway that includes the infrastructure article to inspect or replace, a vehicle, a manufacturer of the infrastructure article, or any other computing device); generate, store, or log an event that indicates a threshold is or is not satisfied that is based at least in part on the infrastructure properties; or perform any other suitable operations. In some example approaches, if the infrastructure data received for a pathway article 108 indicates that the article is counterfeit, a high priority alert is generated to ensure prompt remediation.

In the example of FIG. 8, infrastructure data 532 is at least one of raw data generated by the infrastructure sensor or an identifier of the infrastructure article. An identifier of an infrastructure article may uniquely identify the infrastructure article. In some examples, an identifier of an infrastructure article may identify a type of the infrastructure article. In some examples, infrastructure data 532 comprises an identifier of the infrastructure article and infrastructure data 532 indicates a confidence level that the identifier correctly identifies the type of the infrastructure article. In some examples, the quality metric for a particular article of infrastructure is based on sets of infrastructure data collected over a time series, which may be used to detect trends. In some examples, the quality metric indicates a degree of contrast or a degree of decodability of a visual identifier. In some examples, infrastructure data 532 may include a GPS coordinate set that corresponds to a location of a sign.

In some examples, service component 538 and/or infrastructure component 536 may generate a confidence score associated with the quality metric that indicates a degree of confidence that the quality metric is valid. In some examples, service component 538 and/or infrastructure component 536 may perform one or more operations in response to determining that the quality metric satisfies or does not satisfy a threshold. In some examples, satisfying or not satisfying a threshold may include a value being greater than, equal to, or less than the threshold. In some examples, service component 538 may, in response to a determination that the quality metric does not satisfy a threshold, may notify a custodian of the particular infrastructure article. In some examples, if an article of infrastructure is expected at a particular location by infrastructure component 536, but no data is received that indicate the presence of the article (or data is received indicating the absence of the article) from one or more vehicles, then infrastructure component 536 may perform an operation in response to that determination. For instance, the operation may include, but is not limited to generating an alert to a custodian of the roadway or infrastructure article, generating an alert to one or more other entities, logging the event, or performing any other number of suitable operations. In some examples, service component 538 may, in response to a determination that the quality metric does not satisfy a threshold, notify a vehicle manufacturer. In some examples, service component 538 may determine that the quality metric is more than one standard deviation below the mean for similar infrastructure articles. In some examples, service component 538 may determine an anomaly in a sensor of a vehicle or an environment of the vehicle. In some examples, service component 538 may send an indication of the quality metric to at least one other vehicle for use to modify an operation of the at least one other vehicle in response to detection of the infrastructure article.

In some examples, infrastructure component 536 may determine the quality metric based at least in part on infrastructure data from a plurality of infrastructure sensors that are applied to a model that predicts the quality metric. In some examples, the infrastructure article is retroreflective. In some examples, the infrastructure data descriptive of infrastructure articles comprises a classification that is based at least in part on raw data generated by the infrastructure sensor, and the infrastructure data is generated at the respective vehicle. Raw data may be output generated directly and initially from an infrastructure sensor without additional processing or transforming of the output. For example, the infrastructure data may be the result of pre-processing by the respective vehicle of raw sensor data, wherein the classification comprises less data than the raw data on which the classification is generated. In some examples, infrastructure component 536 may select different sets of infrastructure data from a set of infrastructure data generated by a larger number of vehicles than the set of vehicles. That is, infrastructure component 536 may discard or ignore certain sets of infrastructure data from infrastructure data 532 based on one or more criteria (e.g., anomalous criteria, temporal criteria, locational criteria, or any other suitable criteria). In some examples, at least one infrastructure sensor of each respective vehicle generates raw data descriptive of infrastructure articles that are proximate to the respective vehicle. Each respective vehicle may include at least one computer processor that pre-processes the raw data to generate the infrastructure data, wherein the infrastructure data comprises less data than the raw data. In some examples, the at least one computer processor, to generate the infrastructure data, may generate a quality metric for at least one infrastructure article, and the at least one computer processor may include the quality metric in the infrastructure data.

In some examples, techniques of this disclosure may include collecting crowdsourced infrastructure data; aggregating, analyzing and interpreting that data; preparing it to report or inform infrastructure owner operators of current and future status. Techniques may include preparing to report or inform vehicles on potential adjustments to sensors or reliance on specific sensor modalities. In some examples, the techniques may augment the capabilities of HD maps by providing reliability/quality data as an overlay of additional data for infrastructure in the maps.

In some examples, techniques of this disclosure may provide certain benefits. For automakers and departments of transportation, there may be no available method to provide data from one to the other on specific details of a roadway. Automakers today may collect sensor data to enable their automated driver assistance systems (ADASs), which may be a large volume of data. Likewise, DOT's may spend money and time to ensure their roadways are safe or at least meeting the minimum standards set by Federal and State governing bodies. Some companies may collect information from vehicles to aggregate and resell across many vehicle vendors to create self-healing high-definition maps. Techniques of this disclosure may enable vehicle sourced sensor data to be aggregated and processed through quality scoring techniques in order to generate roadway quality metrics both for use in vehicle and by the DOT or roadway infrastructure owner operator for maintenance and construction planning. The techniques may also link to a road classification system—where a roadway is given an automation readiness score based on the quality of many of the infrastructure components like signs, pavement markings and road surface.

In some examples, application 528 may identify correlations with weather that could be useful to recommend infrastructure upgrades in combination with the number of vehicles depending on a sign (e.g., snow rests on the sign to application 528 recommends a different material that is more appropriate for that location with large volumes of vehicles passing by. In some examples, application 528 may recommend different infrastructure placement.

In some examples, if vehicles are reliably reporting metrics out to an external aggregator such as application 528, then application 528 could also identify statistically significant changes in frequency of quality reports to generate an indicating that a sign might be missing/damaged (i.e.: 200 reads on sign 1, 50 reads on sign 2, 200 reads on sign 3 in series). In some examples, application 528 could use quality evaluation frequency to provide metrics to a department of transportation about road usage and resource priority.

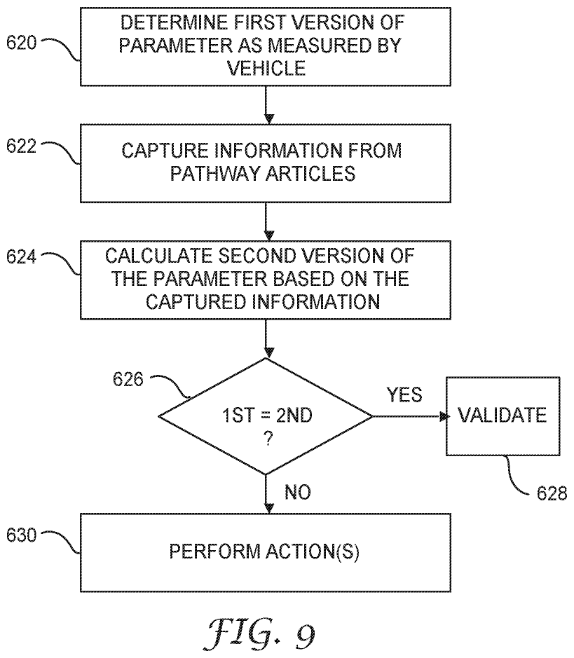

FIG. 9 is a conceptual diagram illustrating via a flowchart an example approach to validating proper operation of a vehicle, in accordance with one or more aspects of the present disclosure. In the flowchart of FIG. 9, a PAAV 110 determines a parameter associated with vehicle operation and saves the determined parameter as a first version of the parameter (620). Sensors or other equipment on PAAV 110 detect and capture information from pathway articles 108 proximate to the PAAV 110 (622) and security component 120 calculates one or more second versions of the parameter based on the captured information (624). In one example approach, security component 120 calculates the one or more second versions of the vehicle operating parameter based on the information captured from two or more of the pathway articles 108 (such as the distance between the two or more pathway articles 108). In one example approach, if one of the second versions of the vehicle operating parameter is not approximately equal to another of the second versions of the vehicle operating parameter, performing, by the vehicle, one or more actions (such as generating an exception or notifying another computing device). In one such example approach, determining whether the second versions of the vehicle operating parameter are approximately equal is a function of a risk factor proportional to a risk involved in acting on the second versions.

PAAV 110 then determines if the first version of the parameter is approximately equal to the second version of the parameter (626) and, if so, validates the vehicle's determination of the parameter (628). If, however, the first version of the parameter is not approximately equal to the second version of the parameter, computer 116 performs at least one action, the at least one action including one or more of generating an exception and notifying computer 134 of the failure to validate (630).

In one example approach, PAAV 110 includes a speedometer. Computing device 116 receives velocity information from the sensors associated with the speedometer and saves the information as a first version of vehicle speed. At the same time, security component 120 calculates the speed of PAAV 110 based on markings embedded in pathway articles 108 as captured, for instance, by image capture devices 102. Computing device 116 then compares the vehicle speed of PAAV 110 determined based on the speedometer to the vehicle speed of the PAAV 110 and flags and exception if the two vehicle speeds differ by more than a threshold value. If not, the vehicle speed determination of the PAAV 110 is validated. If, however, the two vehicle speeds differ by more than a threshold value, computing device 116 notes a problem in determining vehicle speed and generates a failure warning. Computing device 116 and/or computing device 134 may then act to isolate and resolve the source of the error in determining vehicle speed.

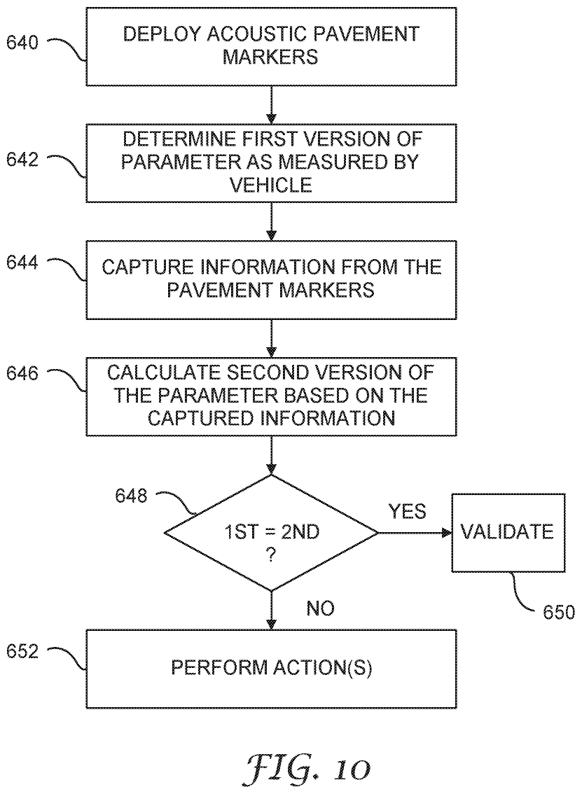

FIG. 10 is a conceptual diagram illustrating via a flowchart another example approach for validating proper operation of a vehicle, in accordance with one or more aspects of the present disclosure. In the flowchart of FIG. 10, a pathway article installer deploys pathway articles 108 along a vehicle pathway 106 (640). In the example shown in FIG. 10, the pathway articles are acoustic pavement markers 108D, but other types of pathway articles may be used as well.

A PAAV 110 traveling on vehicle pathway 106 measures a parameter associated with vehicle operation and saves the measured parameter as a first version of the parameter (642). Sensors or other equipment on PAAV 110 detect and capture information from acoustic pavement markers 108D (644) and security component 120 calculates a second version of the parameter based on the captured information (646). PAAV 110 determines if the first version of the parameter is approximately equal to the second version of the parameter (648) and, if so, validates the vehicle's measurement of the parameter (650). If, however, the first version of the parameter is not approximately equal to the second version of the parameter, computer 116 performs at least one action, such as one or more of generating an exception and notifying an infrastructure authority of the failure to validate (652). In one example approach, a distance between two or more acoustic pavement markers 108D may be used to validate a vehicle's measurement of speed, while the distances between three or more acoustic pavement markers 108D, or any combination of pathway articles 108, may be used to validate a vehicle's measurement of acceleration.

The approach described in FIGS. 9 and 10 provide the basis for a separate ‘channel’ to offer multifactor authentication that the vehicle behavior is appropriate and safe. A difference between the external and internal points of reference may indicate, for instance instrument failure within the PAAV 110 or the presence or residue of a cyber-attack on PAAV 110 and may lead to appropriate intervention. The pathway articles described above provide a trusted point of reference securing the driver assistance-based traffic ecosystem.

As noted above, there is an opportunity to provide redundancy and cyberphysical security to a fixed traffic control infrastructure via pathway articles 108. As described above, properly configured pathway articles may be used as trusted points of reference used to validate connected and autonomous vehicle behavior as being appropriate in accordance with the rules of the road and the current situation. In some example approaches, these trusted points of reference may form part of a new blockchain based solution to provide increased depth and breadth of security, through mutually authenticating peers. In one example approach, information from authenticating peers may be compared and combined with each other to validate safety indicators and vehicle behaviors such as vehicle proximity, orientation, velocity and the relative direction of the roadside materials to the vehicle. This shared authentication may then be used to highlight unauthorized transactions or actions/transactions. For example, a lack of mutual authentication may indicate a potential threat to road safety and may result in immediate intervention. In one example approach, the vehicle ledger may be used in post event analysis of the exception or, in the aggregate as an interstate level record of vehicle events and transactions. This approach also provides a basis to understand vehicle journeys and road safety. Further details of verification and validation of signage information using a security implementation or blockchain is described in U.S. Provisional Patent Application No. 62/580,292, filed Nov. 1, 2017, which is incorporated by reference herein in its entirety.

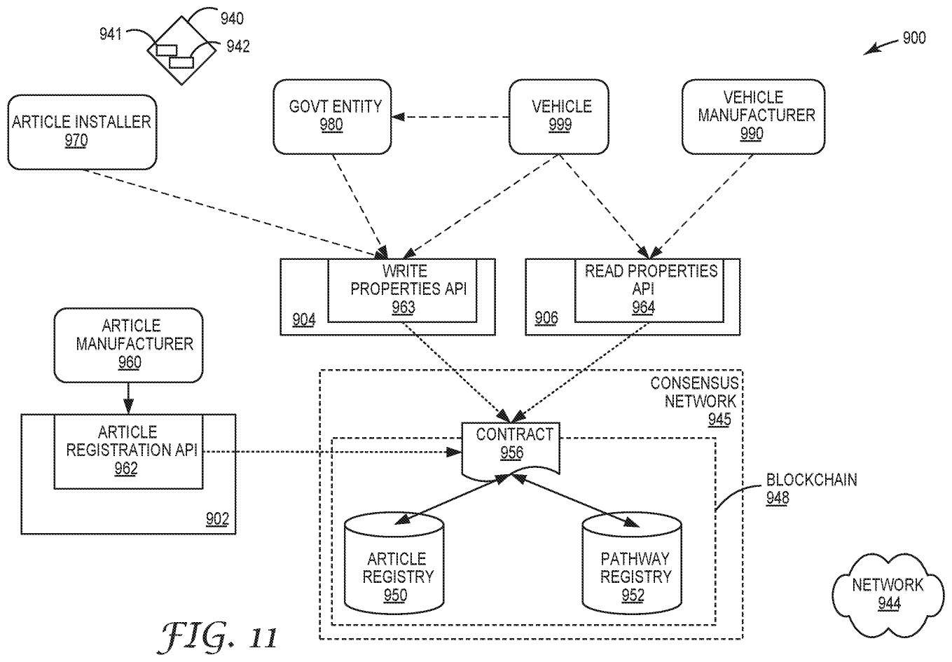

FIG. 11 is a block diagram depicting a system for validating a parameter determined by a vehicle, according to techniques described in this disclosure. In one example approach, computing device 116 may register one or more pathway articles 108 to the blockchain and the authentication information may include one or more unique identifiers that each correspond to a respective article 108. For example, computing device 116 may generate a set of unique identifiers and may send the set of unique identifiers to one or more computing devices (e.g., nodes) that store a blockchain in order to register the set of unique identifiers on the blockchain. In some examples, computing device 116 may request a set of available unique identifiers from one or more computing devices that host the blockchain and may receive an indication of a set of available unique identifiers.

Responsive to receiving a set of unique identifiers or generating the set of unique identifiers, computing device 116 may send an indication of the set of unique identifiers to construction device 138 via computing device 134. Construction device 138 may construct one or more articles 108 such that each article 108 includes an indication of respective identifier from the set of identifiers.

In one example approach, an entity that installs a pathway article 108 may include, with the pathway article or stored in a manner associated with the pathway article, pathway or other information associated with the pathway article, such as pathway information detailing one or more characteristics of the vehicle pathway 106 at which the pathway article is installed, authentication information used to authentic the pathway article or validation information used to validate a parameter determined by a vehicle placing close to the pathway article. In some such examples, computing device 116 may send the information to a consensus network to register an association between authentication information corresponding to an article and the other information associated with the pathway article 108.

Vehicle operation validation system 900 of FIG. 11 includes a consensus network 945 having a blockchain 948, as well as computing devices 902, 904, 906 that present respective article registration API 962, write properties API 963, and read properties API 964 for interacting with the consensus network 945 to register and authenticate transactions with the blockchain 948 using one or more smart contracts 956. In the example approach of FIG. 11, article 940 represents an example of pathway article 108, such as a traffic sign (e.g. a STOP sign, YIELD sign, mile marker, etc.), pavement marking, license plate, etc. In some examples, article 940 may comprise a pathway article that includes a sheeting.

Consensus network 945 is a network of computing devices (or “nodes”) that implement a blockchain 948. Computing devices (not shown in FIG. 11) of the consensus network may represent any computing device able to execute smart contract 956. Consensus network 945 may, for instance, represent an Ethereum network of Ethereum virtual machines (EVMs), also known as an Ethereum blockchain platform, executing on hardware computing devices. Although only one smart contract 956 is illustrated, consensus network 945 may store and execute multiple different smart contracts 956 to facilitate the article registration and authentication and parameter validation techniques described herein.

Blockchain 948 is a shared transactional database that includes a plurality of blocks, each block (other than the root) referencing at least one block created at an earlier time, each block bundling one or more transactions registered with the blockchain 948, and each block cryptographically secured. Consensus network 945 receives transactions from transaction senders that invoke smart contract 956 to modify the blockchain 948 and consensus network 945 uses blockchain 948 for verification. Each block of blockchain 948 typically contains a hash pointer as a link to a previous block, a timestamp, and the transaction data for the transactions. By design, blockchains are inherently resistant to modification of the transaction data. Functionally, blockchain 948 serves as a distributed ledger that can record transactions between parties efficiently and in a verifiable and permanent way.

Consensus network 945 may be a peer-to-peer network that manages blockchain by collectively adhering to a protocol for validating new blocks. Once recorded, the data in any given block of blockchain 948 cannot be altered retroactively without the alteration of all subsequent blocks and a collusion of a majority of the consensus network 945. Only one blockchain 948 is illustrated for simplicity, but multiple blockchains 948 may be used with the described techniques.

Contract 956 may represent a so-called “smart contract.” Contract 956 represents an executable script or program for performing a transaction for a party, or between parties, to modify state of blockchain 948. In examples of consensus network 945 that are Ethereum networks, contract 956 represents one or more autonomous scripts or one or more stateful decentralized applications that are stored in Ethereum blockchain 948 for later execution by the nodes of consensus network 945.

Contract 956 includes operations for modifying and viewing transaction data registered to blockchain. Such transaction data is categorized in FIG. 11 as article registry 950 and pathway registry 952. Blockchain 948 may store all data for article registry 950 and pathway registry 952 to a single blockchain address, or to multiple blockchain addresses, e.g., one address per registry/database. In the case of multiple blockchain addresses, contract 956 may represent multiple corresponding contracts.

System 900 includes a network 944 to transport data communications among computing devices of system 900. Network 944 may include the Internet. Communication links between network 944 and computing devices of system 900 are omitted from FIG. 11.

System 900 includes computing devices 902, 904, and 906. Each of computing devices 902, 904, and 906 may present a different application programming interface (API) for reading or modifying blockchain 948 using contract 956. Computing devices 902, 904, and 906 may communicate with consensus network 945 to request a new blockchain 948 transaction, to read transaction data, or to request that consensus network 945 perform another operation. Computing devices 902, 904, and 906 may send and receive data via network 944 to and from consensus network 945 using JavaScript Object Notation remote procedure call (JSON-RPC), a stateless light-weight remote procedure call. JSON-RPC may operate over sockets, over HyperText Transfer Protocol, or in other message passing environments. Computing devices 902, 904, and 906 may send and receive data for APIs 962, 963, and 964 via network 944. In some cases, a computing device may execute multiple versions of APIs 962, 963, and 964.

Computing device 902 presents article registration API 962, which presents methods for registering an article to blockchain 948. For example, article registration API 962 may include a register method configured to receive authentication information corresponding to article 940. The authentication information may include a unique identifier corresponding to article 940, a location of article 940 (e.g., a location where article 940 is installed or may be installed, also referred to as an expected location), a type of article 940 (e.g., stop sign, yield sign, mile marker, etc.), etc.

An application (not shown) executed by computing device 902 may receive data invoking the register method of article registration API 962 and including data including the authentication information and, in some cases, other article information. The application of computing device 902 may send the authentication information to consensus network 945, at an address for contract 956, to invoke a register method of contract 956. The register method of contract 956 is configured to cause consensus network 945 to receive the authentication information corresponding to an article by adding at least one transaction to article registry 950 of blockchain 948. For example, article manufacturer(s) 960 may invoke the register method of article registration API 926 to register an article 940.

Article manufacturer 960 manufactures articles, e.g., article 940, where each article includes a code 941 representing respective authentication information ((e.g., printed on a surface of the article 940). For instance, article 940 may be a sheeting and the code 941 may be printed, etched, or otherwise included on the sheeting. In another instance, article 940 may be a pathway article (e.g., a traffic sign, a pavement marking, a license plate, etc.) where the code 941 is printed, etched, or otherwise included on the pathway article.

An operator, agent, or device controlled by article manufacturer 960 uses a computing device (e.g., computing device 116) to register each article 940 and the respective authentication information represented by the code 941 by invoking the register method of article registration API 962. Computing device 902, in turn, invokes the register method of contract 956 with the particular authentication information corresponding to article 940. Consensus network executes the register method to add a transaction to the blockchain 948 that modifies article registry 950 to add the authentication information to blockchain 948. For example, article registry 950 represents blocks of blockchain 948 that store authentication information corresponding to a respective article of a plurality of articles 940. In addition to the authentication information corresponding to a respective article, information registered to article registry 950 using article registration API 962 may include other descriptive information associated with a particular article 940, such as manufacturing date, lot number, manufacturer, article specifications, a sign description, and a MUTCD data. Such data may be received and processed by the various methods, similarly to the authentication information for the article.

Computing device 904 presents write properties API 963 that includes at least one method for registering properties of article 940, pathway 106, or both. For example, write properties API 963 may include an article properties method with which an article installer 970 (e.g., a road construction company) or governmental entity 980 (e.g., a department of transportation) may register properties of article 940. For example, the article properties method may enable article installer 970 or governmental entity 980 to associate authentication information corresponding to article 940, such as a type of article 940 (e.g., STOP sign, YIELD sign, speed limit sign, etc.), or location (e.g., GPS coordinates, city, state, intersection, etc.) at which article 940 is originally installed (also referred to as the expected location of article 940) with a unique identifier corresponding to article 940. In some examples, the article properties method may enable an entity to specify other information about article 940, such as installation date, article standards information (e.g., information specified in the Manual on Uniform Traffic Control Devices (MUTCD)), etc.

Applications (not shown) executed by computing device 904 respond to write properties API 963 invocation by invoking contract 956 to cause consensus network 945 to read or modify blockchain 948. For example, an operator, agent, or device controlled by an article installer 970 and/or governmental entity 980 uses a computing device (e.g., computing device 116A) to invoke write properties API 963, specifying the additional information about article 940 in order to cause the additional information about article 940 to be associated with article 940 within blockchain 948.

In other words, the article properties method may permit article installers 970, governmental entity 980, or other user to specify additional information about article 940. In such cases, the article properties method is configured to receive the additional authentication information associated with article 940 and invoke a corresponding method of contract 956 to cause consensus network 945 to register an association between first authentication information (e.g., a unique identifier) corresponding to article 940 and second authentication information corresponding to article 940 in article registry 950 by adding at least one transaction to blockchain 948.

In some examples, article 940 includes article information 942. In some example approaches, article information 942 includes, for instance, pathway information, authentication information and validation information. Write properties API 963 may include a pathway properties method with which article installer 970 or governmental entity 980 may register properties of a vehicle pathway (e.g., pathway 106 of FIGS. 1 and 6). For example, the pathway properties method may enable article installer 970 or governmental unit 980 to specify pathway information about a particular portion of pathway 106, such as a location (e.g., GPS coordinates), number of lanes, lane width, speed limit, pathway grade or slope, pathway curvature, etc. An application executed by computing device 904 may respond to the invocation of the pathway method of write properties API 963 by invoking contract 956 to cause consensus network 948 to register the pathway information about the particular portion of pathway 106. In some examples, invocation of the pathway method may cause consensus network 945 to register an association between authentication information corresponding to article 940 and pathway or other information stored on pathway article 108.

Computing device 906 presents read properties API 964 by which parties may request information from blockchain 948. In some examples, read properties API 964 includes an authentication method configured to receive authentication information for an article and return an indication of whether the consensus network 945 is able to authenticate the article. In some examples, read properties API 964 includes a method configured to provide a record of vehicle operating parameter validations performed based on article information 942 associated with article 940.

Computing device 906 may receive data invoking the authentication method of read properties API 964 and including authentication information for an article for which authentication is being requested. Computing device 906 may send data including the authentication information for the article to consensus network 945, at an address for contract 956, to invoke a corresponding authentication method of contract 956. The authentication method of contract 956 is configured to cause consensus network 945 to review transactions in blockchain 948 to determine whether the authentication information corresponding to article 940 exists within article registry 950 of blockchain 948. For example, the authentication method of contract 956 may compare the authentication information corresponding to article 940 to authentication information stored by article registry 950 to determine whether the authentication information corresponding to article 940 corresponds to (e.g., matches) authentication information within article registry 950. In some examples, the existence of the authentication information corresponding to article 940 within article registry 950 may indicate that article 940 is authentic. In other words, responsive to determining that the authentication information corresponding to article 940 corresponds to authentication information within article registry 950, read properties API 964 may return an indication that the article 940 is authentic. However, in some examples, if the authentication method determines that the authentication information corresponding to article 940 does not correspond to authentication information within article registry 950, read properties API 964 may output an indication that the article 940 is not authentic (e.g., is counterfeit).

In some examples, read properties API 964 may utilize additional information in determining whether article 940 is authentic. For example, the data received by computing device 906 may include an indication of the type of article 940 and/or a location of article 940. Computing device 906 may invoke the authentication method of contract 956 cause consensus network 945 to compare the type of article 940 with an expected type of article for article 940 as stored within article registry 940. In some example, read properties API 964 may output an indication that article 940 is not authentic (e.g., is counterfeit) in response to the authentication method determining that the type of article 940 does not correspond to the expected type of article 940 as stored within article registry 950 (e.g., even if the authentication information corresponding to article 940 matches authentication information within article registry 950). Similarly, read properties API 964 may output an indication that article 940 is authentic in response to the authentication method determining that the type of article 940 corresponds to the expected type of article 940 as stored within article registry 950 (e.g., in further response to determining the authentication information corresponding article 940 matches authentication information within article registry 950).

As another example, computing device 906 may invoke the authentication method of contract 956 to cause consensus network 945 to compare a location of article 940 (e.g., GPS coordinates, city, state, intersection, etc.) with an expected location of article 940 as stored within article registry 940. In some example, read properties API 964 may output an indication that article 940 is authentic in response to the authentication method determining that the location of article 940 corresponds to (e.g., is within a threshold distance of) the expected location of article 940 as stored within article registry 950 (e.g., and in further response to determining the authentication information corresponding to article 940 matches a authentication information within article registry 950). Similarly, read properties API 964 may output an indication that article 940 is not authentic in response to the authentication method determining that the location of article 940 does not correspond the expected location of article 940 as stored within article registry 950 (e.g., even if the authentication information corresponding article 940 matches authentication information within article registry 950). Once authenticated, properly configured pathway articles 940 may be used as trusted points of reference used to validate connected and autonomous vehicle behavior as being appropriate in accordance with the rules of the road and the current situation, as described above.

In one example approach, system 900 validates a vehicle's ability to determine its location. In one such example approach, a location is read from a pathway article 940 and compared to a location determined, for instance, based on the vehicle's GPS. If the locations are approximately the same, the vehicle's ability to determine location is validated and the validation transaction is recorded in blockchain 948. Similar validations, such as validations of speed, environmental conditions, etc., may be performed by a computer 116 in a vehicle 999, such as PAAV 110 as described above. In one example approach, vehicle 999 writes the outcome of the validation process to blockchain 948 as a validation transaction. In another example approach, vehicle 999 notifies a governmental entity of the outcome of the validation process and the governmental entity writes the outcome to blockchain 948 as a validation transaction associated with vehicle 999. In yet another example approach, vehicle 999 notifies a governmental entity of the outcome of the validation process and the governmental entity writes the outcome to blockchain 948 as an aggregation of validation transactions associated with vehicles 999.

In another such example, location information is not stored as part of article information 942 but is, instead, available via lookup. In one such example approach, read properties API 964 includes a lookup method configured to receive information associated with an article and to return such information when requested. For example, computing device 906 may receive data identifying article 940. Computing device 906 may send the data to consensus network 945, at an address for contract 956, to invoke a corresponding lookup method of contract 956. In one example approach, the lookup method of contract 956 is configured to cause consensus network 945 to review transactions in blockchain 948 to determine article information associated with article 940. In some examples, vehicle 999 may control or adjust operation of vehicle 999 in response to receiving the article information. For example, vehicle 999 may receive pathway information indicating that the pathway includes a curve and may turn the wheels of vehicle 999 to navigate through the curve. In this way, vehicle 999 may control vehicle 999 based on pathway information received from blockchain 948 in addition to, or in replacement of, information received by sensors of vehicle 999.

System 900 thus provides a mechanism for validating the operation of vehicles using mutually authenticating peers of a consensus network 945. The validation transactions generated using pathway articles 108 and registered by vehicles to the blockchain 948 using write properties API 963 may be used by subsequent vehicles to validate their expected next operations using read properties API 964. As such, validation transactions registered to pathway registry 952 represent the state of a pathway 106 as understood by vehicles previously traversing or otherwise operating on the pathway 106.

The blockchain 948 can be updated by a consensus of vehicles detecting pathway articles 108 and patterns 111 and registering validation transactions, or more simply by registering the detection of such articles 108 and patterns 111 by the vehicles. For example, vehicles may register detected patterns 111 using write properties API 963. The state of pathway 106 at a location is indicated by a consensus, e.g. a majority or other threshold percentage of recent transactions, of transactions registered by vehicles with respect to the location.

In some examples, patterns 111 and/or pathway articles 108 may be points of reference in a series of transactions for vehicles traversing a pathway 106. Read properties API 964 may provide a method to obtain a series of transactions registered by vehicles traversing a pathway 106 at a location. PAAV 110 may use the series of transactions to validate PAAV 110 operation. For example, vehicle control component 144 may output an indication of an upcoming or anticipated operation (e.g., turn left, set speed to 55 MPH). Security component 120 of PAAV 110 may determine, based on the series of transactions from the blockchain 948 and recent operations by PAAV 110 represented in the series of transactions, that the upcoming operation is materially different from the next expected transaction in the series of transactions, which is represented as the next most likely transaction in the blockchain 948 ledger. Alternatively, security component 120 may provide the upcoming operation to computing device 906 as a transaction to be validated in a request for validation using a method of read properties API 964. Consensus network 945 may attempt to validate the transaction using the series of transactions stored to pathway registry 952. Computing device 906 returns a result (valid/invalid) of the validation attempt to the PAAV 110. Based on the validation information, security component 120 may perform one or more actions to, e.g. intervene, modify the subsequent operation of PAAV 110, and/or output an alert to the driver. In this way the blockchain 948 ledger enables these types of record transactions to be used as a basis for predicting a next operation of PAAV 110, which may provide the technical advantages of safeguarding the vehicle from authenticated yet false inputs that would otherwise be overlooked.

In addition to validation as described above, PAAV 110 may register its upcoming operation to the blockchain 948 using write properties API 963. As a result, such information may be memorialized to blockchain 948. Other PAAVs or the pathway infrastructure may extrapolate from such upcoming operations registered to the blockchain 948 to identify deviation, either in later reported intentions/actions, or through sensor input to PAAVs that can trigger an exception, as described elsewhere in this disclosure. That is, in addition to direct safety applications (e.g., upcoming transaction validation), this information could be memorialized by roadside devices for insurance and diagnostic purposes so that fault could be determined from a reliable record of multiple PAAVs' decisions and actions. Registration of such information may be used to debug or otherwise improve road infrastructure and PAAV operations where new edge case behaviors are discovered on the pathway and vehicles do not respond optimally. In other words, by having a log of decisions and anticipated operations, adequate information is stored to the blockchain 948 as to be useful for improvements in an ecosystem with many vendors and algorithm implementations.

In some examples, the read properties API 964 invokes a method of contract 956 that accesses only a subset of recent blocks of blockchain 948. In some cases, non-recent blocks may be discarded and thus no longer part of pathway registry 952.

In some examples, one or more of article installers 970, government entities 980, vehicle manufacturers 990, and/or vehicles 999 may be a node within consensus network 945 and may host a copy of blockchain 948. For example, various government entities (e.g., city, county, or state governments, such as a Department of Transportation) may store blockchain 948.

In some examples, vehicle 999 may be included within consensus network 945 and may store a copy of blockchain 948. In such examples, vehicle 999 may authenticate an article 940 or may validate a vehicle's ability to measure an operating parameter by directly traversing article registry 950 of blockchain 948. In some examples, vehicle 999 may authentic an article 940 or may validate a vehicle's ability to measure an operating parameter by receiving data from another entity (e.g., an entity that stores the blockchain).

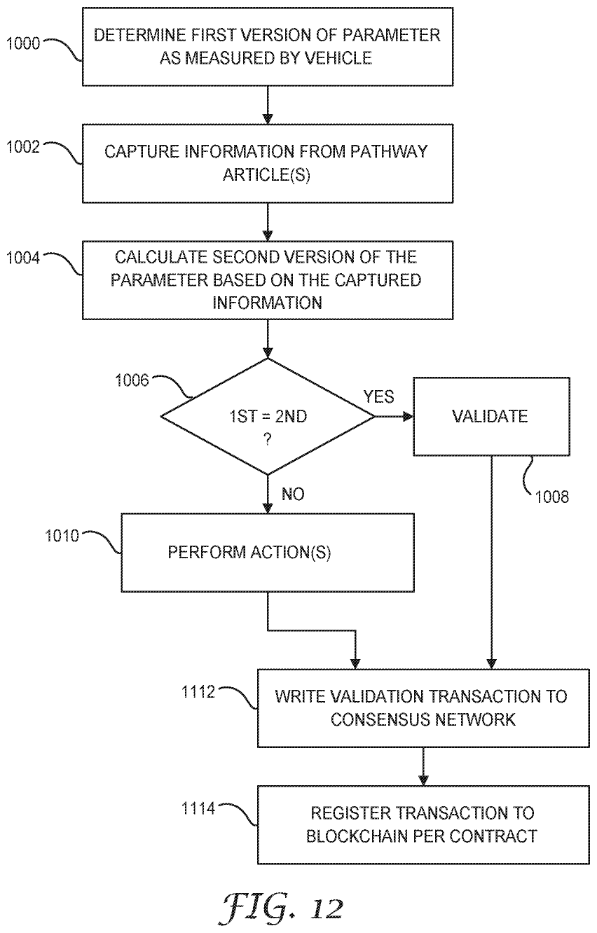

FIG. 12 is a flow diagram illustrating example operations of a computing device configured to validate a parameter determined by a vehicle via information associated with a pathway article, in accordance with one or more techniques of this disclosure. The techniques are described in terms of computing device 116 of FIG. 7. However, the techniques may be performed by other computing devices.

In the example approach of FIG. 12, blockchain 948 stores a smart contract 956 at a blockchain address. Computing device 116 measures a parameter associated with vehicle operation and saves the measured parameter as a first version of the parameter (1000). Sensors or other equipment on PAAV 110 detect and capture information from pathway articles 108 proximate to the PAAV 110 (1002) and security component 120 of computing device 116 calculates a second version of the parameter based on the captured information (1004). In one example approach, security component 120 calculates the second version of the vehicle operating parameter based on the information captured from two or more of the pathway articles 108 (such as the distance between the two or more pathway articles 108). PAAV 110 then determines if the first version of the parameter is approximately equal to the second version of the parameter (1006) and, if so, validates the vehicle's measurement of the parameter (1008). If, however, the first version of the parameter is not approximately equal to the second version of the parameter, computer 116 performs at least one action, the at least one action including generating an exception, notifying computing device 134 of the failure to validate and notifying an infrastructure authority of the failure to validate (1010). Computing device 116 then writes a validation transaction recording the results to blockchain 948 (1012). Consensus network 945 executes the register method of smart contract 956 to add the validation transaction to article registry 950 of blockchain 948 (1014).

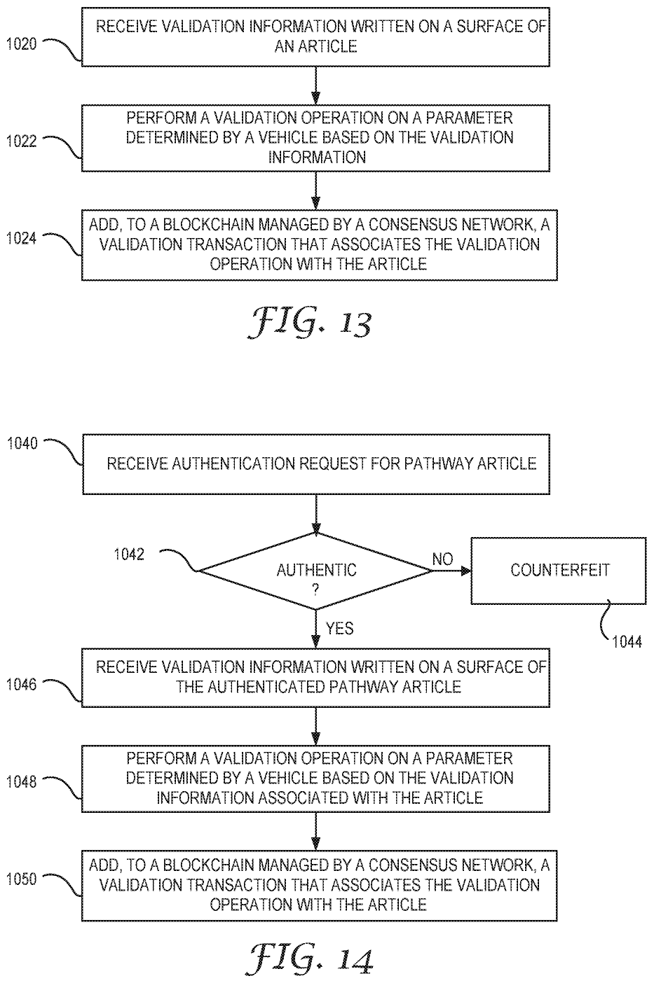

FIG. 13 is flowchart illustrating an example mode of operation for a consensus network, according to techniques of this disclosure. The operations are described with respect to elements of system 900 of FIG. 11 but may be applied by systems having different architectures.

Blockchain 948 stores a smart contract 956 at a blockchain address. At least one node of the consensus network 945 receives information encoded in a code 941 marked on a surface on an article 940 (1020). The information may include validation information used to validate a vehicle performance measurement. For example, the validation information may include a unique identifier corresponding to article 940, an expected location of article 940, a type of article 940, a type of validation operation supported by article 940, data needed to perform such validation operations, or a combination thereof. The types of operations validated may include operations performed by PAAV 110 that determine, for instance, speed, acceleration, traction, pathway condition, location, precipitation and distance to objects. Computing device 116 performs a validation operation validating a parameter determined by a vehicle such as PAAV 110 (1022). Computing device 116 then writes a validation transaction recording the results to blockchain 948 (1024).

In one example approach, consensus network 945 executes the register method of smart contract 956 to add the transaction to article registry 950 of blockchain 948. In another example approach, computing device 116 executes the article properties method of smart contract 956 to add a transaction to article registry 950 of blockchain 948 that registers the results of the validation process.

FIG. 14 is flowchart illustrating an example mode of operation for a consensus network, according to techniques of this disclosure. The operations are described with respect to elements of system 900 of FIG. 11 but may be applied by systems having different architectures.

As noted above, validation operations may rely on external trusted points of reference. In one example approach, an authenticated pathway article 108 or 940 may serve as such an external trusted point of reference. One example approach for authenticating a pathway article includes reading authentication information such as an article identifier from the pathway article and authenticating based on the article identifier. In some examples, computing device 116 receives the authentication information from an image capture system (e.g., LIDAR or other systems that capture light in the visible and/or infrared spectrums). For example, image capture circuitry 103 may capture one or more images of a pathway article. Interpretation component 118 may detect a code 127 that includes authentication information in at least one of the images.

In one example approach, blockchain 948 stores a smart contract 956 at a blockchain address. A node of consensus network 945 receives a request for authentication of a pathway article 940, the request specifying authentication information corresponding to pathway article 940 (1040). For example, a computing device, such as computing device 116 as illustrated in FIGS. 1 and 6, may detect a pathway article 940 via one or more image capture devices 102 and may send a request to the node for authentication of the detected article. For instance, the request may include an indication of a unique identifier encoded in a code 941 on the pathway article, a location of the vehicle when the pathway article was detected, a type of the pathway article, or a combination therein.

Consensus network 945 executes the article properties method of smart contract 956 to determine whether the article is authentic or counterfeit (1042). A node of the consensus network may determine whether the article is authentic based at least in part on a unique identifier corresponding to the detected pathway article. For example, a node of the consensus network may determine that article 940 is authentic if the unique identifier corresponding to the detected article corresponds to (e.g., matches) an identifier stored within the blockchain managed by the consensus network, or may determine that the article is not authentic (e.g., counterfeit) if the unique identifier corresponding to the detected article does not correspond to an identifier stored within the blockchain.

In some examples, the consensus network determines whether the detected pathway article is authentic further based on additional authentication information, such as a location of a computing device that detects the pathway article, a type of the pathway article, or both. For instance, consensus network 945 may determine the pathway article is not authentic (e.g., counterfeit) responsive to determining that the location of computing device 116 is not within a threshold distance of the expected location of the pathway article or responsive to determining that the type of the detected pathway article does not correspond to the expected type.

Consensus network 945 outputs an indication of whether the article is authentic or counterfeit. For example, responsive to determining that the article is not authentic or is counterfeit (“Counterfeit” branch of 1042), consensus network 945 outputs an indication that the article is not authentic (1044). For example, a node of consensus network 945 may send a notification to computing device 116 indicating the article is not authentic.

On the other hand, responsive to determining that the article is authentic (“Authentic” branch of 904), consensus network 945 outputs an indication to computing device 116 that the article is authentic. For example, consensus network 445 may executes the register method of smart contract 456 to add a transaction to article registry 450 of blockchain 448 (604).

Once a pathway article is authenticated, it can be used as an external trusted point of reference. In one example approach, consensus network 945 outputs an indication to computing device 116 that the article is authentic.

At least one node of the consensus network 945 receives an indication of process validation information encoded in a code 941 marked on a surface of article 940 (1046). For example, the process validation information may include a unique identifier corresponding to article 940, an expected location of article 940, a type of article 940, a type of validation operation supported by article 940, data needed to perform such validation operations, or a combination thereof. The types of operations validated may include operations performed by PAAV 110 that determine, for instance, speed, acceleration, traction, pathway condition, location, precipitation and distance to objects.

Computing device 116 performs a validation operation validating a parameter determined by a vehicle such as PAAV 110 based on the validation information read from pathway article 940 (1048). Consensus network 945 may then execute the article properties method of smart contract 956 to add a transaction to article registry 950 of blockchain 948 that records the outcome of the validation operation (1050).

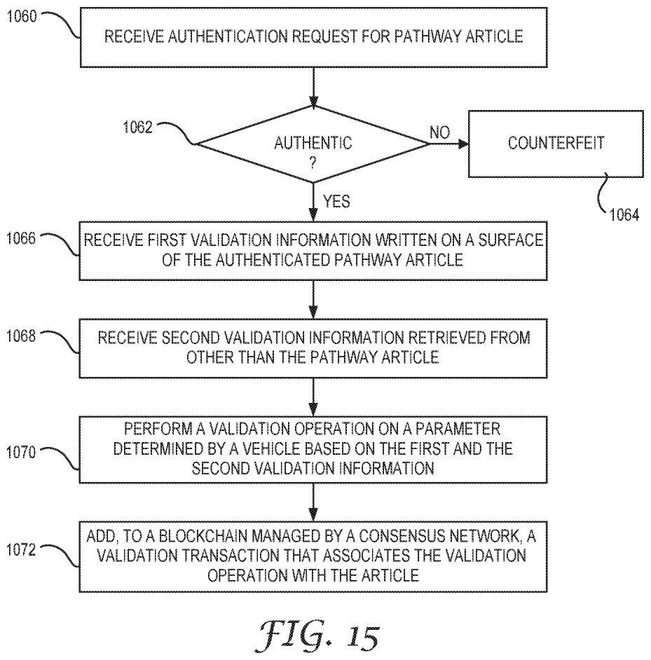

FIG. 15 is flowchart illustrating an example mode of operation for a consensus network, according to techniques of this disclosure. The operations are described with respect to elements of system 900 of FIG. 11 but may be applied by systems having different architectures.

Once again, an authenticated pathway article 108 or 940 may serve as such an external trusted point of reference. In one example approach, however, validation information is not only read from the pathway article (first validation information) but also may be stored within system 100 (second validation information).

In one example approach, blockchain 948 stores a smart contract 956 at a blockchain address. A node of consensus network 945 receives a request for authentication of a pathway article 940, the request specifying authentication information corresponding to pathway article 940 (1060). For example, a computing device, such as computing device 116 as illustrated in FIGS. 1 and 6, may detect a pathway article 940 via one or more image capture devices 102 and may send a request to the node for authentication of the detected article. For instance, the request may include an indication of a unique identifier encoded in a code 941 on the pathway article, a location of the vehicle when the pathway article was detected, a type of the pathway article, or a combination therein.

Consensus network 945 executes the article properties method of smart contract 956 to determine whether the article is authentic or counterfeit (1062). Consensus network 945 outputs an indication of whether the article is authentic or counterfeit. For example, responsive to determining that the article is not authentic or is counterfeit (“NO” branch of 1062), consensus network 945 outputs an indication that the article is not authentic (1064). For example, a node of consensus network 945 may send a notification to computing device 116 indicating the article is not authentic.

On the other hand, responsive to determining that the article is authentic (“YES” branch of 904), consensus network 945 outputs an indication to computing device 116 that the article is authentic. For example, consensus network 445 may execute the register method of smart contract 456 to add a transaction to article registry 450 of blockchain 448.

Once a pathway article is authenticated, it can be used as an external trusted point of reference. In one example approach, consensus network 945 outputs an indication to computing device 116 that the article is authentic.

In one example approach, at least one node of the consensus network 945 receives an indication of first process validation information encoded in a code 941 marked on a surface of article 940 (1066). At least one node of the consensus network 945 also receives an indication of the second process validation information stored elsewhere (1068). For example, the first process validation information may include a unique identifier corresponding to article 940 and the second validation information may include an expected location of article 940, a type of article 940, a type of validation operation supported by article 940, data needed to perform such validation operations, or a combination thereof. The types of operations validated may include operations performed by PAAV 110 that determine, for instance, speed, acceleration, traction, pathway condition, location, precipitation and distance to objects.

Computing device 116 performs a validation operation validating a parameter determined by a vehicle such as PAAV 110 based on the first and second validation information (1070). Consensus network 945 may then execute the article properties method of smart contract 956 to add a transaction to article registry 950 of blockchain 948 that records the outcome of the validation operation (1072).

The system described above relates to passive (signs/lines with codes) active (dynamic link through coded materials) and actively enabled materials such as RFID devices or roadside processing units as part of a traffic control infrastructure. Authenticated pathway articles provide trusted points of reference securing the traffic control system, allowing one to verify that roadside material and infrastructure are authentic.

Without trusted points of reference, it can be difficult to detect variations in or failure in measurement of operating parameters. For instance, a driver of PAAV 110 may try to accelerate the vehicle to 30 MPH. If the PAAV accelerates to 120 mph, the system may have failed or been compromised. If computing device 116 cannot calculate speed independently, such an error may not be detected.

On the other hand, in a system that provides a trusted point of reference for determining speed, a driver of PAAV 110 may try to accelerate the vehicle to 30 MPH. If the PAAV accelerates to 120 mph, the system may have failed or been compromised. If computing device 116 can calculate speed independently, such an error will be detected and PAAV 110 will generate an alert. The vehicle may then be recovered through driver intervention. In these scenarios, pathway articles 108 provide Out of Band Authentication (OOBA) to determine the true speed of the vehicle (e.g. #pulses/second of wet reflective or radar reflective markers) to alert the driver, emergency services and more. The number of pulses per second and a known distance between the pathway articles enables computing the true speed of the vehicle according to distance=rate*time.

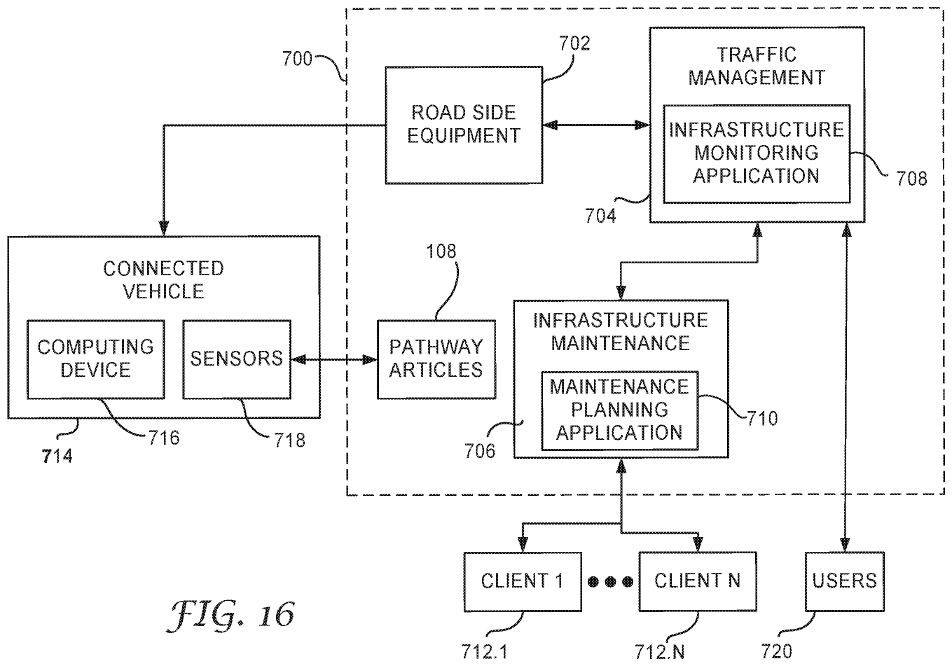

FIG. 16 is a workflow diagram illustrating the collection and processing of vehicle sensor data, in accordance with one or more aspects of the present disclosure. In the example of FIG. 16, infrastructure management system 700 includes road side equipment 702, pathway articles 108, traffic management system 704, and infrastructure management service provider 706. In the example approach shown in FIG. 16, traffic management system 704 includes an infrastructure monitoring application 708 while infrastructure management service provider 706 includes a maintenance planning application 710. Clients 712.1-712.N are connected to maintenance planning application 710 and, in some example approaches, use maintenance planning application 710 to deploy and track pathway articles 722, to track infrastructure quality and to plan and perform maintenance.

In operation, in the example approach of FIG. 16, road side equipment 702 is in wireless communication with vehicles 714. Road side equipment 702 is also connected in wired or wireless communication with traffic management system 704. Service provider 706 and data users 720 are connected to traffic management system 704 and retrieve data from traffic management system 704 that was collected and aggregated from vehicles 714 via road side equipment 702. In one such approach each connected vehicle includes a computing device 716 and sensors 718. In one example approach, computing device 716 operates in a similar manner to the example computing devices 116 described above.

In operation, a computing device 716 in each vehicle 714 collects information from pathway articles 722 proximate to the vehicle via sensors 718 in the manner described above. Road side equipment 702 then collects that information from each of the vehicles 714. In some example approaches, vehicles 714 in proximity to specific pieces of road side equipment 702 also collect such information from adjacent roadways and, as such, provide an opportunity for cooperation, for example, between city and state department of transportation.

In one example approach, traffic management system 704 prepares and transmits a request to the road side equipment 702 requesting information from vehicles 714 proximate to road side equipment 702. In turn, road side equipment 702 broadcasts the request to computing device 716 on each vehicle 714 in range. Each computing device 716 responds with the current values of those data types that it has available. Road side equipment 702 receives the response and forwards the response to traffic management system 704. The infrastructure monitoring application 708 collates, smooths and stores the data received. In one example approach, the infrastructure monitoring application 708 pushes data out to maintenance planning application 710 and in other example approaches, infrastructure monitoring application 708 stores the data in a database accessible by maintenance planning application 710, by other planning applications executing in service provider 706 and by users 720. As such, system 700 provides a mechanism for the accumulation of data on road conditions and the quality and authenticity of infrastructure from a variety of data provided by computing devices 716.

In some example approaches, service provider 706 offers a cloud-based service to clients 712.1 through 712.N that can be used by local government entities to monitor and maintain their road and pathway article infrastructure. Such approaches may be used, for example, to monitor conditions of the roadway and pavement marking, to monitor and maintain the efficacy of pathway articles along the roadway, or to validate measurements by vehicle 714. In some such approaches, feedback from vehicle cameras and other sensors provide information needed to support such applications. Vehicle sensors 718 may, in some example approaches, be used to capture information embedded in signage or in pavement markings that can be used to better understand the condition and efficacy of the signage and pavement markings.

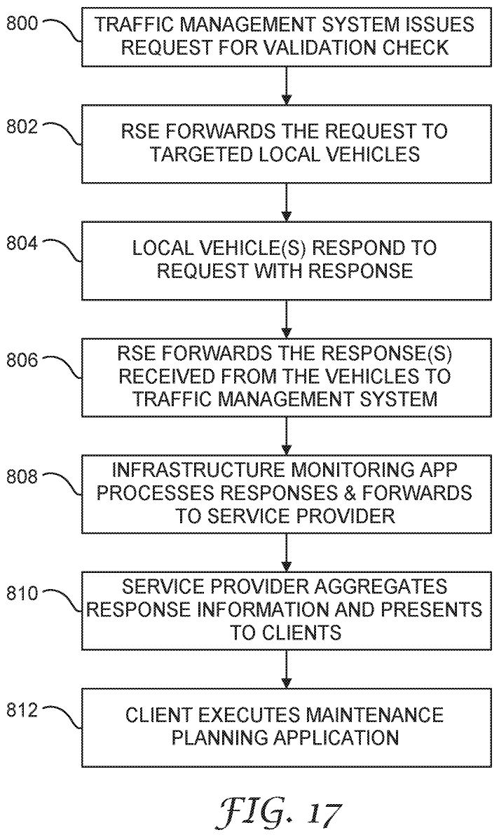

Example applications of infrastructure management system 700 are described next. FIG. 17 is a conceptual diagram illustrating via a flowchart an example approach to out-of-band vehicle operating parameter validation, in accordance with one or more aspects of the present disclosure. In the example approach of FIG. 17, traffic management system 704 periodically issues a request (800) to road side equipment (RSE) 702. RSE 702 then transmits the request to computing devices 716 of one or more vehicles 714 (802). The request may include a request for a computing device 716 to determine the validity of one or more operating parameter measurements.

In some example approaches, the traffic management system request is distributed from traffic management system 704 to one or more embodiments of RSE 702 via a wired or wireless communication channel. In some such example approaches, each RSE 702 distributes the traffic management system request to computing devices 716 of one or more connected vehicles 714 near RSE 702 via Dedicated Short-Range Communications (DSRC), a two-way short-to-medium range wireless communications capability that permits very high data transmission in active safety applications. Connected vehicle applications include communications among connected vehicles 714 used to avoid crashes, communications between vehicles and infrastructure (via RSE 702) to enable safety, mobility and efficiency, and communications between vehicles, infrastructure and passengers' wireless devices to provide continuous real-time connectivity to all system users.

In one example approach, a computing device 716 receives a traffic management system request to determine the validity of one or more operating parameter measurements of vehicle 714. (802). The information may include information the computing device 716 collected from one or more pathway articles via sensors 718. In some such example approaches, only the information requested that has changed since the last transmission is transmitted to RSE 702. In some example approaches, a probe segment number ties the response to the traffic management system request issued by traffic management system 704.

RSE 702 receives may receive a message from the computing devices 716 of local vehicles 714 (804) and may forward the message to traffic management system 704 (806). In one example approach, vehicle 714 reads information from pathway articles 108 and uses that information to validate one or more of the operating parameter measurements by vehicle 714. In one such example approach, an infrastructure monitoring application 708 in traffic management system 704 receives the information transmitted by each vehicle 714 and aggregates the data if desired before forwarding the data to service provider 706 (808). In some example approaches, infrastructure monitoring application 708 also stores the data in a local database so it is accessible at any time by, for instance, service provider 706 and users 720. Service provider 706 aggregates the data as appropriate and forwards the aggregated data to one or more of clients 712.1 through 712.N (810). Each client 712 then executes maintenance planning software on the maintenance planning application 710 of service provider 706 or on maintenance planning software installed at the client 712 (812).

As described above, infrastructure management system 700 provides a mechanism to take advantage of sensors in advanced driver assistance systems (ADAS) to monitor and maintain critical driving infrastructure. For instance, not only does system 700 collect sensor information such as accelerometer readings to determine road conditions, it also is able to obtain associated confidence scores for the readings that, when combined with readings from other vehicles, provide increased assurance that the readings are correct. Car manufacturers may use that information to determine the accuracy and effectiveness of their ADAS offerings. Municipal and state authorities may use the information to determine needed maintenance. And traffic control applications executing in, for instance, traffic management system 704 may use the information to determine the level of autonomy permitted to connected vehicles 714 for a section of road based on the condition of the road and the condition of other aspects of the infrastructure.

The above approaches give transportation officials the ability to respond rapidly to deterioration in road surface, pavement markings and signage, using infrastructure that is available to monitor and enable traffic. In addition, the above approaches provide a mechanism for monitoring subcontractor operations and effectiveness. Finally, the above approaches provide a mechanism for the measurement of the performance of ADAS implementations on different connected vehicles 714 that can be used for feedback to original equipment manufacturers (OEMs).

Infrastructure monitoring may also extend beyond a given roadway. For instance, an RSE 702 can solicit and accept sensor data from connected vehicles on roadways other than the roadway being monitored. Such data can be used to provide information on the other roadways to the appropriate agencies. Such an approach may create an opportunity for cooperation for example between city and state departments of transportation.

In some example approaches, connected vehicles 714 push safety-related information from the OBU 716 to traffic management system 704. On some such example approaches, data is pushed at a predefined rate. The rate can increase if a vehicle 714 determines that there is a safety issue for vehicle 714 or any of the vehicles around vehicle 714.

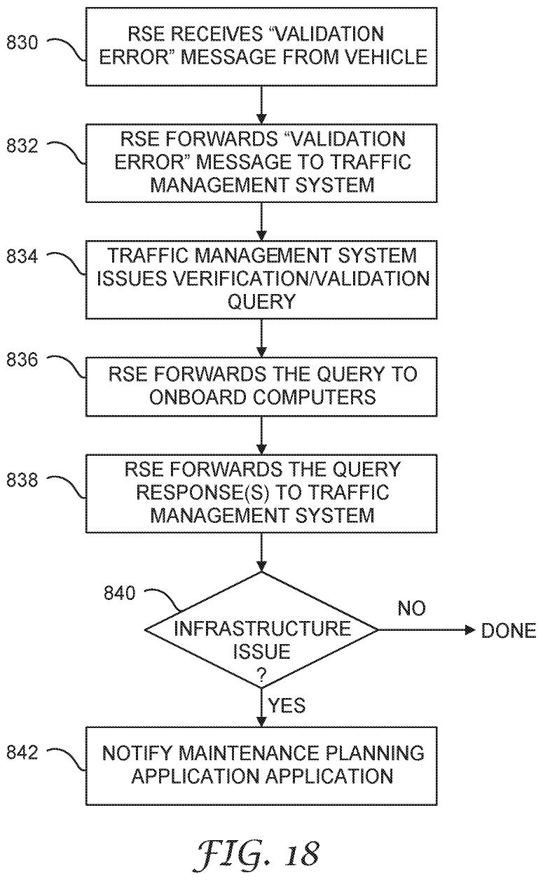

FIG. 18 is a workflow diagram illustrating the collection and processing of vehicle sensor data used for maintaining pathway articles such as traffic signs, in accordance with one or more aspects of the present disclosure. In the example of FIG. 18, infrastructure management system 700 includes road side equipment 702, traffic management system 704, and infrastructure management service provider 706. In the example approach shown in FIG. 18, traffic management system 704 includes an infrastructure monitoring application 708 while infrastructure management service provider 706 includes a sign maintenance application 910. Clients 712.1-712.N are connected to sign maintenance application 710 and, in some example approaches, use sign maintenance application 710 for the tracking of sign inventory and quality and for maintenance planning and execution.

In operation, in the example approach of FIG. 16, road side equipment 702 is in wireless communication with vehicles 714. Road side equipment 702 is also connected in wired or wireless communication with traffic management system 704. Service provider 706 and data users 720 are connected to traffic management system 704 and retrieve data from traffic management system 704 that was collected and aggregated from vehicles 714. In one such approach each connected vehicle includes sensors 718 and an computing device 716. In operation, road side equipment 702 will be collecting data from vehicles on the agency's roadway, however the vehicles 714 in proximity to each piece of road side equipment 702 will also be collecting data from adjacent roadways and, as such, provides an opportunity for cooperation for example between city and state department of transportation.

As noted above, in one example approach, traffic management system 704 prepares and transmits a traffic management system request to the road side equipment 702 requesting information from vehicles 714 proximate to road side equipment 702. In turn, road side equipment 702 broadcasts the request to computing device 716. Each computing device 716 responds with the current values of those data types that it has available. Road side equipment 702 receives the response and forwards the response to traffic management system 704. The infrastructure monitoring application 708 collates, smooths and stores the data received. In one example approach, the infrastructure monitoring application 708 pushes data out to sign maintenance application 710 and in other example approaches, infrastructure monitoring application 708 stores the data in a database accessible by sign maintenance application 710, by other planning applications executing in service provider 706 and by users 720. As such, system 700 provides a mechanism for the accumulation of data on road conditions and the quality of infrastructure from a variety of data provided by computing devices 716.

In one example approach, sign maintenance application uses the flowchart of FIG. 8 to receive asset information from vehicles 714 as they detect and decode infrastructure articles on or around the roadway. Each vehicle 714 may collect a series of data elements such as the presence and location of various assets owned and maintained by infrastructure owner operators. This information may be used by sign maintenance application 710 to update the asset management database for an agency, as well as to provide notifications if assets have not been visualized for an extended period of time—prompting investigation/maintenance request. This information may also be used by sign maintenance application 710 to detect issues with pathway articles and to undertake steps to obtain further information on signs when needed.

FIG. 18 is a conceptual diagram illustrating via a flowchart an example approach to maintenance planning, in accordance with one or more aspects of the present disclosure. In the example approach of FIG. 18, sign maintenance application 710 within service provider 706 has received an indication that some aspect of the infrastructure is potentially compromised. In one example approach, sign maintenance system application 710 has received information on one or more pathway articles from vehicles 714 as the vehicles 714 detected and decoded infrastructure articles on or around the roadway 106. The information may include data elements such as the presence and location of various assets such as signs owned and maintained by the agency using sign maintenance application 710 and may also include a confidence level associated with the quality of each sign.

In one example approach, sign maintenance application 710 issues a probe management request to traffic management system 704 (1000) in response to detecting a problem with a sign. The probe management request may, for instance, ask traffic management system 704 to task vehicles 714 in the vicinity of the sign to capture a higher-resolution image of the sign, or may ask traffic management system 704 to ask vehicles 714 in the vicinity of the sign for increased resolution in one or more of the image capture or sensor readings. Traffic management system 704 issues a traffic management system request to RSE 702 with the desired request (1002). RSE 702 then transmits the traffic management system request (1004) to computing devices 716 of one or more vehicles 714.

In one example approach, each OBU 716 that receives a probe management message replies to that message with the information requested (1006). The information may include information the sign maintenance application 710 requested that the OBU 716 collected from one or more sensors 718. In some such example approaches, only the information requested that has changed since the last transmission is transmitted to RSE 702. In some example approaches, a probe segment number ties the response to the probe management message issued by traffic management system 704.

RSE 702 receives the message from the OBUs 716 of local vehicles 714 tasked to provide information and forwards the messages to traffic management system 704 (1008). Infrastructure monitoring application 708 in traffic management system 704 receives the information received from each vehicle 714 and aggregates the data if desired before forwarding the data to sign maintenance application 710 in service provider 706 (1010). In some example approaches, infrastructure monitoring application 708 also stores the data in a local database so it is accessible at any time by, for instance, service provider 706 and users 720. In some example approaches, service provider 706 aggregates the data as appropriate and forwards the aggregated data to one or more of clients 712.1 through 712.N.

In one example approach, each client 712 executes maintenance planning software on the sign maintenance application 710 of service provider 706 or on sign maintenance planning software installed at the client 712. In some example approaches, the information may further be used to update the asset management database for the agency stored in the cloud by service provider 706 or stored in a local database by the agency. The information may be used as well as to provide notifications if assets (such as traffic signs) have not been seen for an extended period of time—prompting investigation/maintenance request.

The above example is illustrative of the ability of software executing within infrastructure management system 700 to accumulate and infer road conditions from a variety of data provided by probe management requests and probe management messages. Such an approach allows users of system 700 to optimize use of roadway maintenance capabilities based on real roadway conditions, locate and assess assets deployed on or around the roadway, and gather data from third-party onboard vehicle applications through DSRC mechanisms. In some example approaches, applications downloaded by service provider 706 and traffic management system 704 further expand the amount and quality of data provided by the computing devices 716 of connected vehicles 714. The result is a crowd-sourced supply of data from individual vehicles 714 and a system that allows rapid response to infrastructure marking and signage deterioration based on the crowd-sourced data.

FIG. 18 is a conceptual diagram illustrating via a flowchart an example approach to out-of-band validation of vehicle operating parameter measurements, in accordance with one or more aspects of the present disclosure. In the example approach of FIG. 18, a vehicle retrieved validation information from a trusted pathway article 108 and determined that one or more operating parameter measurements are not correct, as described above. RSE 702 receives a message from one or more of the vehicles 714 indicating that a validation procedure has failed (830). RSE 702 forwards the message to TMS 704 (832) and receives back a verification/validation query from TMS 704 (834). RSE 704 forwards the verification/validation query to one or more of the vehicles 714 (836). RSE 702 receives query responses from one or more of the vehicles 714 and forwards the response to TMS 704 (838). In one example approach, TMS 840 determines if the issue is a vehicle problem or an infrastructure problem (840) and notifies the maintenance planning application if the issue is an infrastructure problem (842).

In another example approach, TMS 704 simply queries the blockchain to determine whether the issues that led to the validating procedure failing are due to vehicle issues or are due to infrastructure problems.

In one example approach, service provider 706 aggregates the data as appropriate and provides a roadway quality report to one or more of clients 712.1 through 712.N. In one such example approach, the report includes a heat map showing problem areas along roadway 106. In some example approaches, the information received from TMC 704 may further be used to update the asset management database for the agency stored in the cloud by service provider 706 or stored in a local database by the agency. The information may be used as well as to provide notifications if assets (such as traffic signs) have not been seen for an extended period of time—prompting investigation or a maintenance request.

The following examples provide other techniques for creating portions of the article message in a pathway article, in which some portions, when captured by an image capture device, may be distinguishable from other content of the pathway article. For instance, a portion of an article message, such as a security element may be created using at least two sets of indicia, wherein the first set is visible in the visible spectrum and substantially invisible or non-interfering when exposed to infrared radiation; and the second set of indicia is invisible in the visible spectrum and visible (or detectable) when exposed to infrared. Patent Publication WO/2015/148426 (Pavelka et al.) describes a license plate comprising two sets of information that are visible under different wavelengths. The disclosure of WO/2015/148426 is expressly incorporated herein by reference in its entirety. In yet another example, a security element may be created by changing the optical properties of at least a portion of the underlying substrate. U.S. Pat. No. 7,068,434 (Florczak et al.), which is expressly incorporated by reference in its entirety, describes forming a composite image in beaded retroreflective sheet, wherein the composite image appears to be suspended above or below the sheeting (e.g., floating image). U.S. Pat. No. 8,950,877 (Northey et al), which is expressly incorporated by reference in its entirety, describes a prismatic retroreflective sheet including a first portion having a first visual feature and a second portion having a second visual feature different from the first visual feature, wherein the second visual feature forms a security mark. The different visual feature can include at least one of retroreflectance, brightness or whiteness at a given orientation, entrance or observation angle, as well as rotational symmetry. Patent Publication No. 2012/240485 (Orensteen et al.), which is expressly incorporated by reference in its entirety, describes creating a security mark in a prismatic retroreflective sheet by irradiating the back side (i.e., the side having prismatic features such as cube corner elements) with a radiation source. U.S. Patent Publication No. 2014/078587 (Orensteen et al.), which is expressly incorporated by reference in its entirety, describes a prismatic retroreflective sheet comprising an optically variable mark. The optically variable mark is created during the manufacturing process of the retroreflective sheet, wherein a mold comprising cube corner cavities is provided. The mold is at least partially filled with a radiation curable resin and the radiation curable resin is exposed to a first, patterned irradiation. Each of U.S. Pat. Nos. 7,068,464, 8,950,877, US 2012/240485 and US 2014/078587 are expressly incorporated by reference in its entirety.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques may be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples of the disclosure have been described. These and other examples are within the scope of the following claims.

1. A method of validating operation of a vehicle, comprising:
determining, by the vehicle, a first version of a vehicle operating parameter via a vehicle instrument employed in a first measurement approach;
calculating, by the vehicle, a second version of the vehicle operating parameter based on information indicated by two or more pathway articles associated with a vehicle pathway;
determining, by the vehicle, if the first version of the vehicle operating parameter is approximately equal to the second version of the vehicle operating parameter;
if the first version of the vehicle operating parameter is approximately equal to the second version of the vehicle operating parameter, validating the first measurement approach; and
if the first version of the vehicle operating parameter is not approximately equal to the second version of the vehicle operating parameter, performing, by the vehicle, one or more actions.

2. The method of claim 1, further comprising:
obtaining, by the vehicle, the information indicated by the two or more pathway articles by applying one or more vehicle sensors to the pathway articles.

3. The method of claim 1, wherein the two or more pathway articles include two pavement markers deployed at a known spacing in pavement marking material.

4. The method of claim 1, wherein the two or more pathway articles are embodied in a pavement marking material comprising a tape applied to the vehicle pathway.

5. The method of claim 1,
wherein respective locations of the two or more of the pathway articles define a pattern, and
wherein calculating a second version of the vehicle operating parameter based on the information indicated by the two or more of the pathway articles comprises detecting the pattern.

6. The method of claim 5, wherein calculating a second version of the vehicle operating parameter based on the information indicated by the two or more of the pathway articles comprises mapping the detected pattern to the information indicated by the two or more of the pathway articles.

7. The method of claim 1, wherein pairs of the two or more pathway articles are separated by a distance, the method further comprising:
determining the distance,
wherein calculating a second version of the vehicle operating parameter based on the information indicated by the two or more of the pathway articles comprises computing a speed of the vehicle based on the distance.

8. The method of claim 1, wherein the two or more pathway articles include a pavement marker and an enhanced sign, wherein the pavement marker and the enhanced sign are located at known positions relative to the vehicle.

9. The method of claim 1, wherein the each of the two or pathway articles are optically active.

10. The method of claim 1, further comprising:
receiving, by the vehicle from at least one image capture device, one or more images of the two or more pathway articles,
wherein calculating a second version of the vehicle operating parameter based on the information indicated by the two or more of the pathway articles comprises identifying the two or more of the pathway articles in the one or images.

11. A system comprising:
a set of vehicles, each respective vehicle in the set of vehicles comprising:
at least one infrastructure sensor that generates infrastructure data descriptive of infrastructure articles that are proximate to the respective vehicle; and
a first communication device to transmit the infrastructure data; and
a computing device comprising one or more computer processors, a second communication device, and a memory comprising instructions that when executed by the one or more computer processors cause the one or more computer processors to:
determine a first version of a vehicle operating parameter via a vehicle instrument employed in a first measurement approach;
capture information stored in pathway articles deployed along a pathway;
calculate a second version of the vehicle operating parameter based on the information captured from the pathway articles;
determine if the first version of the vehicle operating parameter is approximately equal to the second version of the vehicle operating parameter;
if the first version of the vehicle operating parameter is approximately equal to the second version of the vehicle operating parameter, validate the first measurement approach; and
if the first version of the vehicle operating parameter is not approximately equal to the second version of the vehicle operating parameter, generate an exception.

12. The system of claim 11, wherein the instructions further include instructions that when executed by the one or more computer processors cause the one or more computer processors to apply one or more vehicle infrastructure sensors to the pathway articles to capture the information.

13. The system of claim 12, wherein one of the vehicle infrastructure sensors includes an image capturing device and wherein the information captured is extracted from an image captured by the image capturing device of one or more of the pathway articles.

14. The system of claim 11, wherein the instructions further include instructions that when executed by the one or more computer processors cause the one or more computer processors to detect a pattern in placement of two or more of the pathway articles and to calculate the second version of the vehicle operating parameter based on the detected pattern.

15. The system of claim 11, wherein the instructions further include instructions that when executed by the one or more computer processors cause the one or more computer processors to detect a pattern in placement of a pavement marker and an enhanced sign and to calculate the second version of the vehicle operating parameter based on the detected pattern.

16. The system of claim 11, wherein the instructions further include instructions that when executed by the one or more computer processors cause the one or more computer processors to detect a pattern in placement of a pavement marker and an enhanced sign and to calculate the second version of the vehicle operating parameter based on the detected pattern.

17. A pathway article, comprising:
a pavement marking material; and
a pavement marker attached to the pavement marking material, wherein the pavement marker includes information used to validate a measurement approach used by a vehicle to determine a vehicle operating parameter.

18. The pathway article of claim 17, wherein the pavement marking material is a tape.

19. The pathway article of claim 17, wherein the pavement marker is optically active.

20-49. (canceled)
